(19) United States
(12) Patent Application Publication
(10) Pub. No.: US 2016/0062636 A1
(43) Pub. Date: Mar. 3, 2016

(54) MOBILE TERMINAL AND CONTROL METHOD THEREOF

(71) Applicant: LG ELECTRONICS INC., Seoul (KR)

(72) Inventors: Beobki JUNG, Seoul (KR); Eunyoung SHIN, Seoul (KR); Kyungtae OH, Seoul (KR); Youngmin KWON, Seoul (KR); Seungju CHOI, Seoul (KR)

(73) Assignee: LG ELECTRONICS INC., Seoul (KR)

(21) Appl. No.: 14/725,301

(22) Filed: May 29, 2015

(30) Foreign Application Priority Data
Sep. 2, 2014 (KR) 10-2014-0116348
Sep. 12, 2014 (KR) 10-2014-0121195

(51) Int. Cl. G06F 3/0488; G06F 3/0484

(52) U.S. Cl. CPC G06F 3/04883; G06F 3/04847; G06F 3/04842

(57) ABSTRACT

A mobile terminal including a touch screen configured to display an object associated with an application; and a controller configured to receive a touch input applied to the object and a pivot gesture input applied based on a touch point of the received touch input, and activate an interface setting mode for changing a user interface associated with executing the application based on the pivot gesture.

### CROSS-REFERENCE TO RELATED APPLICATION

Pursuant to 35 U.S.C. §119(a), this application claims the benefit of earlier filing date and right of priority to Korean Application No. 10-2014-0116348, filed on Sep. 2, 2014, and Korean Application No. 10-2014-0121195, filed on Sep. 12, 2014, the contents of which are incorporated by reference herein in their entireties.

### BACKGROUND OF THE INVENTION

1. Field of the Invention

This specification relates to a mobile terminal which is touch-sensitive and a control method thereof.

2. Background of the Invention

Terminals may be generally classified as mobile/portable terminals or stationary terminals. Mobile terminals may also be classified as handheld terminals or vehicle mounted terminals.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs. As it becomes multifunctional, a mobile terminal can capture still images or moving images, play music or video files, play games, receive broadcast and the like, so as to be implemented as an integrated multimedia player.

Icons associated with a plurality of applications may be output on a display unit of the mobile terminal, and thus a user can apply inputs to those icons to corresponding applications. Meanwhile, under specific situations, such as a user being unable to use their hands or while driving a car, it may be difficult to execute an application by applying a touch input to the display unit or control an output screen through a touch input. Thus, the user has to enter a setting menu of the mobile terminal to preset an input manner of a control command as a touch gesture or a gesture input is limitedly allowed for several control commands. This causes the user's inconvenience.

### SUMMARY OF THE INVENTION

Therefore, an aspect of the detailed description is to provide a mobile terminal and corresponding method for switching a user interface relating to an execution of an application into another touch-based user interface by using a touch input with respect to an icon of the corresponding application.

Another aspect of the detailed description is to provide a mobile terminal and corresponding method for selecting or adding a plurality of user interfaces, different from one another, using a touch input with respect to an application.

Another aspect of the detailed description is to provide a mobile terminal and corresponding method for changing a configuration of an execution screen of an application to be appropriate for a selected user interface.

Another aspect of the detailed description is to provide a mobile terminal and corresponding method for providing new UI and UX, which use a movement of a finger after a touch input is applied to a touch pad of the mobile terminal.

To achieve these and other advantages and in accordance with the purpose of this specification, as embodied and broadly described herein, the present invention provides in one aspect a mobile terminal including a touch screen configured to display an object associated with an application, and receive a touch input applied to the object; and a controller configured to receive a touch input applied to the object and a pivot gesture input applied based on a touch point of the received touch input, and activate an interface setting mode for changing a user interface associated with executing the application.

In another aspect, the present invention provides a mobile terminal including a touch screen configured to display an object associated with an application; and a controller configured to receive a touch input applied to the object, execute the application and display an execution screen of the executing application, receive a pivot gesture input on the displayed execution screen, and change a user interface for executing the application based on the received pivot gesture input.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate embodiments and together with the description serve to explain the principles of the invention.

In the drawings:

FIG. 1A is a block diagram of a mobile terminal in accordance with one embodiment of the present invention;

FIGS. 1B and 1C are conceptual views illustrating one example of the mobile terminal viewed from different directions;

FIGS. 2(a) to 2(d) are conceptual views illustrating a representative operating method of a mobile terminal in accordance with one embodiment disclosed herein;

FIG. 3 is a flowchart illustrating an operating method of a mobile terminal in accordance with one embodiment disclosed herein;

FIGS. 4A(a) to 4A(d), 4B(a) to 4B(d), 4C(a) to 4C(d), and 4D(a) to 4D(d) are conceptual views illustrating methods of registering an application to which a switched (changed) user interface is to be applied, in a mobile terminal in accordance with one embodiment disclosed herein;

FIGS. 5(a) to 5(d) are conceptual views illustrating a method of releasing a registration of an application to which the switched user interface is applied, in a mobile terminal in accordance with one embodiment disclosed herein;

FIGS. 6A(a) to 6A(c), 6B(a) to 6B(c), 6C(a) to 6C(d) are conceptual views illustrating a method of selecting a user interface to switch (change) using a touch input applied to an icon of an application, in a mobile terminal in accordance with one embodiment disclosed herein;

FIGS. 7A(a) to 7A(d) and 7B(a) and 7B(b) are conceptual views illustrating a method of adding another user interface while an execution screen of an application is output, and a method of adjusting a configuration of a screen accordingly, in a mobile terminal in accordance with one embodiment disclosed herein;

FIGS. 8(a) to 8(d) are conceptual views illustrating a method of processing an event generated in a touch-based application, in an output state of an execution screen of an application to which a switched user interface is applied, in a mobile terminal in accordance with one embodiment disclosed herein;

FIGS. 9A(a) to 9G(c) are detailed views illustrating a control of an execution screen of an application using a gesture interface, in a mobile terminal in accordance with one embodiment disclosed herein;

FIGS. 10(a) to 10(d) are conceptual views of a mobile terminal in accordance with another embodiment disclosed herein;

FIG. 11 is a flowchart illustrating a control method of a mobile terminal in accordance with another embodiment disclosed herein;

FIGS. 12A(a) to 12A(d), 12B(a) to 12B(b), and 12C(a) to 12C(b) are conceptual views illustrating a pivot gesture applied onto a touchpad;

FIGS. 13(a) to 13(d) are conceptual views illustrating a control method of a mobile terminal based on attribute information related to a pivot gesture;

FIGS. 14A(a) to 14A(c) and 14B(a) to 14B(b) are conceptual views illustrating a control method of a mobile terminal using a pivot gesture while a camera capturing function is executed;

FIGS. 15(a) and 15(b) are conceptual views illustrating a control method of a mobile terminal for controlling an output direction of a display unit using a pivot gesture; and

FIGS. 16(a) to 16(c) are conceptual views illustrating a method of outputting a guide image associated with a movement of a cover portion of a mobile terminal in accordance with another embodiment disclosed herein.

### DETAILED DESCRIPTION OF THE INVENTION

Description will now be given in detail according to embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function.

The accompanying drawings are used to help easily understand various technical features and it should be understood that the embodiments presented herein are not limited by the accompanying drawings. As such, the present invention should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another. When an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

In this application, the terms “comprising” and “including” should not be construed to necessarily include all of the features, numbers, steps, operations, constituting elements, components or combinations thereof disclosed herein, and should be construed not to include some of the elements or steps thereof, or should be construed to further include additional elements or steps.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

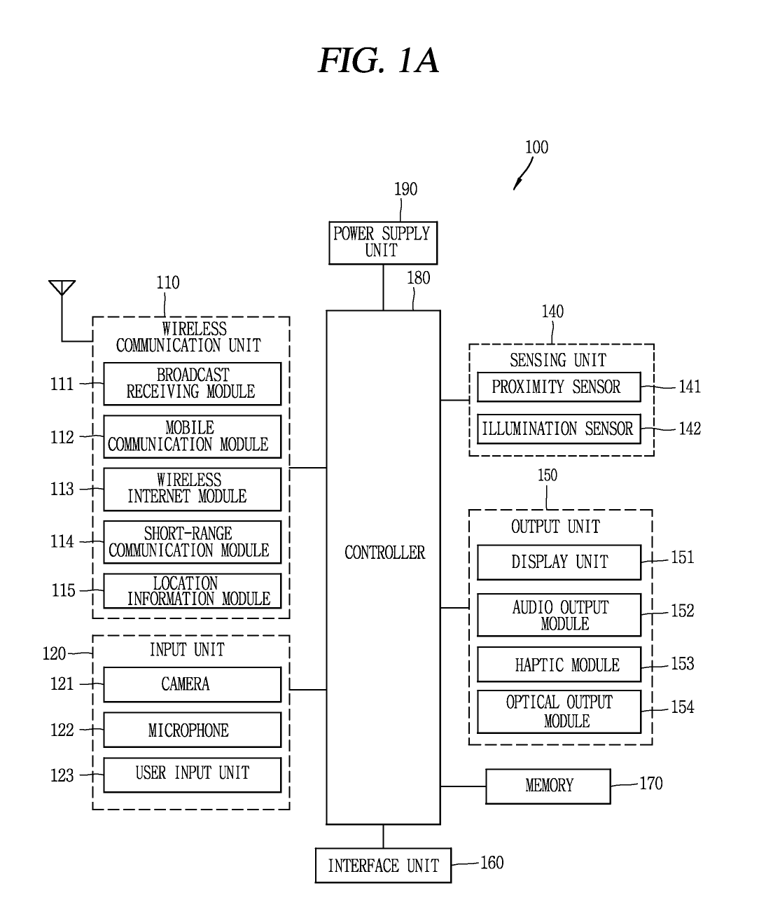

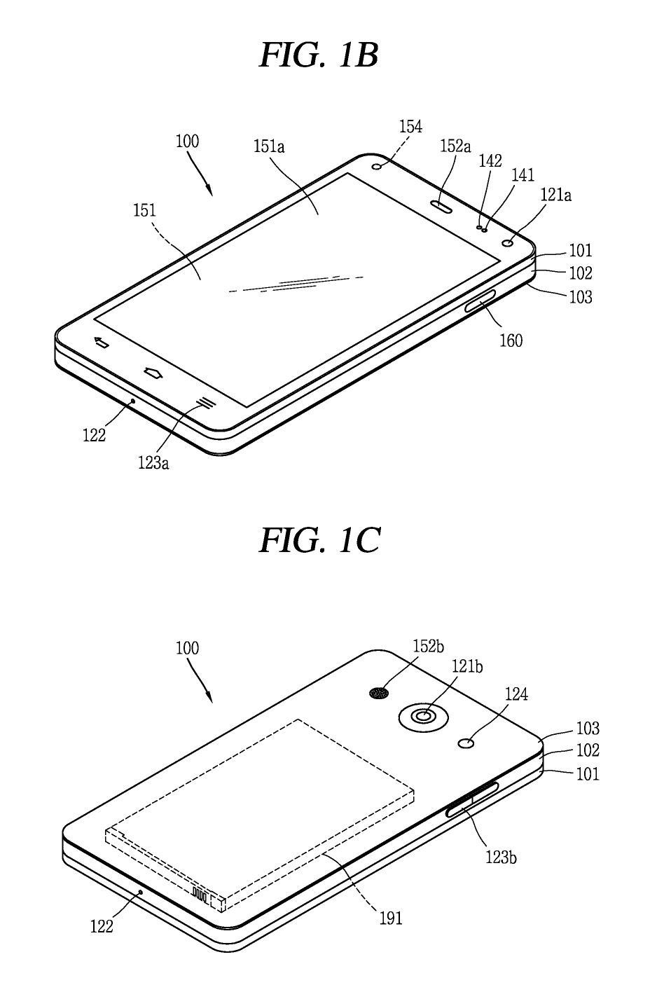

Reference is now made to FIGS. 1A-1C, where FIG. 1A is a block diagram of a mobile terminal in accordance with the present invention, and FIGS. 1B and 1C are conceptual views of one example of the mobile terminal, viewed from different directions.

The mobile terminal 100 may include components such as a wireless communication unit 110, an input unit 120, a sensing unit 140, an output unit 150, an interface unit 160, a memory 170, a controller 180, and a power supply unit 190. Implementing all of the illustrated components is not a requirement, and that greater or fewer components may alternatively be implemented.

In more detail, the wireless communication unit 110 may typically include one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 may typically include one or more modules which connect the mobile terminal 100 to one or more networks

The wireless communication unit 110 may include one or more of a broadcast receiving module 111, a mobile communication module 112, a wireless Internet module 113, a short-range communication module 114, and a location information module 115.

The input unit 120 may include a camera 121 or an image input unit for obtaining images or video, a microphone 122, which is one type of audio input device for inputting an audio signal, and a user input unit 123 (for example, a touch key, a mechanical key, and the like) for allowing a user to input information. Data (for example, audio, video, image, and the like) may be obtained by the input unit 120 and may be analyzed and processed according to user commands.

The sensing unit 140 may typically be implemented using one or more sensors configured to sense internal information of the mobile terminal, the surrounding environment of the mobile terminal, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The mobile terminal disclosed herein may be configured to utilize information obtained from one or more sensors of the sensing unit 140, and combinations thereof.

The output unit 150 may typically be configured to output various types of information, such as audio, video, tactile output, and the like. The output unit 150 may be shown having at least one of a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 can provide or process information or functions appropriate for a user by processing signals, data, information and the like, which are input or output by the aforementioned various components, or activating application programs stored in the memory 170.

Also, the controller 180 controls some or all of the components illustrated in FIG. 1A according to the execution of an application program that have been stored in the memory 170. In addition, the controller 180 can control at least two of those components included in the mobile terminal to activate the application program.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least part of the components may cooperatively operate to implement an operation, a control or a control method of a mobile terminal according to various embodiments disclosed herein. Also, the operation, the control or the control method of the mobile terminal may be implemented on the mobile terminal by an activation of at least one application program stored in the memory 170.

Hereinafter, description will be given in more detail of the aforementioned components with reference to FIG. 1A, prior to describing various embodiments implemented through the mobile terminal 100.

First, regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), Wideband CDMA (WCDMA), High Speed Downlink Packet access (HSDPA), High Speed Uplink Packet Access (HSUPA), Long Term Evolution (LTE), LTE-advanced (LTE-A) and the like).

Examples of the wireless signals include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE) , LTE-advanced (LTE-A) and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LET-A, and the like, as part of a mobile communication network, the wireless Internet module 113 performs such wireless Internet access.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

Here, another mobile terminal (which may be configured similarly to mobile terminal 100) may be a wearable device, for example, a smart watch, a smart glass or a head mounted display (HMD), which can exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of at least part of data processed in the mobile terminal 100 to the wearable device via the short-range communication module 114. Hence, a user of the wearable device may use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

The location information module 115 is generally configured to detect, calculate, derive or otherwise identify a position (or current position) of the mobile terminal. As an example, the location information module 115 includes a Global Position System (GPS) module, a Wi-Fi module, or both. For example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module. If desired, the location information module 115 may alternatively or additionally function with any of the other modules of the wireless communication unit 110 to obtain data related to the position of the mobile terminal. The location information module 115 is a module used for acquiring the position (or the current position) and may not be limited to a module for directly calculating or acquiring the position of the mobile terminal.

The input unit 120 may be configured to permit various types of inputs to the mobile terminal 120. Examples of such inputs include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. Meanwhile, the cameras 121 may be arranged in a matrix configuration to permit a plurality of images having various angles or focal points to be input to the mobile terminal 100. Also, the cameras 121 may be located in a stereoscopic arrangement to acquire left and right images for implementing a stereoscopic image.

The microphone 122 processes an external audio signal into electric audio (sound) data. The processed audio data can be processed in various manners according to a function being executed in the mobile terminal 100. If desired, the microphone 122 may include assorted noise removing algorithms to remove unwanted noise generated in the course of receiving the external audio signal.

The user input unit 123 is a component that permits input by a user. Such user input may enable the controller 180 to control operation of the mobile terminal 100. The user input unit 123 may include one or more of a mechanical input element (for example, a mechanical key, a button located on a front and/or rear surface or a side surface of the mobile terminal 100, a dome switch, a jog wheel, a jog switch, and the like), or a touch-sensitive input element, among others. As one example, the touch-sensitive input element may be a virtual key, a soft key or a visual key, which is displayed on a touch screen through software processing, or a touch key which is located on the mobile terminal at a location that is other than the touch screen. Further, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like, and generate a corresponding sensing signal. The controller 180 generally cooperates with the sending unit 140 to control operation of the mobile terminal 100 or execute data processing, a function or an operation associated with an application program installed in the mobile terminal based on the sensing signal. The sensing unit 140 may be implemented using any of a variety of sensors, some of which will now be described in more detail.

The proximity sensor 141 refers to a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this instance, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data (or information) according to whether a touch with respect to a point on the touch screen is either a proximity touch or a contact touch.

A touch sensor can sense a touch (or a touch input) applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 can sense which region of the display unit 151 has been touched. Here, the touch controller may be a component separate from the controller 180, the controller 180, and combinations thereof.

Meanwhile, the controller 180 can execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121, which has been depicted as a component of the input unit 120, typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

Also, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented so the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a flash memory type, a hard disk type, a solid state disk (SSD) type, a silicon disk drive (SDD) type, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 can typically control the general operations of the mobile terminal 100. For example, the controller 180 can set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected. As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like. As an alternative to the example in which the plurality of cases form an inner space for accommodating components, the mobile terminal 100 may be configured such that one case forms the inner space. In this example, a mobile terminal 100 having a uni-body is formed so synthetic resin or metal extends from a side surface to a rear surface.

If desired, the mobile terminal 100 may include a waterproofing unit for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include a display unit 151, first and second audio output module 152a and 152b, a proximity sensor 141, an illumination sensor 142, an optical output module 154, first and second cameras 121a and 121b, first and second manipulation units 123a and 123b, a microphone 122, an interface unit 160, and the like.

Hereinafter, as illustrated in FIGS. 1B and 1C, description will be given of the mobile terminal 100 in which the front surface of the terminal body is shown having the display unit 151, the first audio output module 152a, the proximity sensor 141, the illumination sensor 142, the optical output module 154, the first camera 121a, and the first manipulation unit 123a, the side surface of the terminal body is shown having the second manipulation unit 123b, the microphone 122, and the interface unit 160, and the rear surface of the terminal body is shown having the second audio output module 152b and the second camera 121b.

FIGS. 1B and 1C depict certain components as arranged on the mobile terminal. However, alternative arrangements are possible and within the teachings of the instant invention. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. For example, the display unit 151 may display execution screen information of an application program executing at the mobile terminal 100 or user interface (UI) and graphic user interface (GUI) information in response to the execution screen information.

The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a receiver for transferring call sounds to a user's ear and the second audio output module 152b may be implemented in the form of a loud speaker to output alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this instance, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output module 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof. Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side due to the touch screen or rear input unit replacing at least some functions of the first manipulation unit 123a provided on the front of the terminal body, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities. A flash 124 is shown adjacent to the second camera 121b. When an image of a subject is captured with the camera 121b, the flash 124 may illuminate the subject.

The second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

The controller 180 of the mobile terminal according to the embodiment which may include at least one of those aforementioned constituting elements may output an object corresponding to at least one application on the display unit which is sensitive to touch. The controller 180 can execute (or activate) an interface setting mode for changing (switching) a user interface associated with an execution of the application corresponding to the object, in response to sensing of a pivot gesture input, which is applied based on a touch point, on which a touch input applied to the object is sensed.

Here, ‘pivot gesture input’ may refer to an input of changing a part of a touch point, on which a touch input applied to an object output on the display unit 151 is sensed, based on the touch point. Or, ‘pivot gesture input’ may refer to an input applied by a continuous movement of a touch object (a touch tool, a material, or the like), which applies a touch input to an object output on the display unit 151, starting from (based on) a touch point on which the touch input is sensed.

Hereinafter, description will be first given of a method of changing a user interface associated with an execution of an application corresponding to an object through an interface setting mode, and then given in detail of a method of entering the interface setting mode for changing the user interface of the application corresponding to the object.

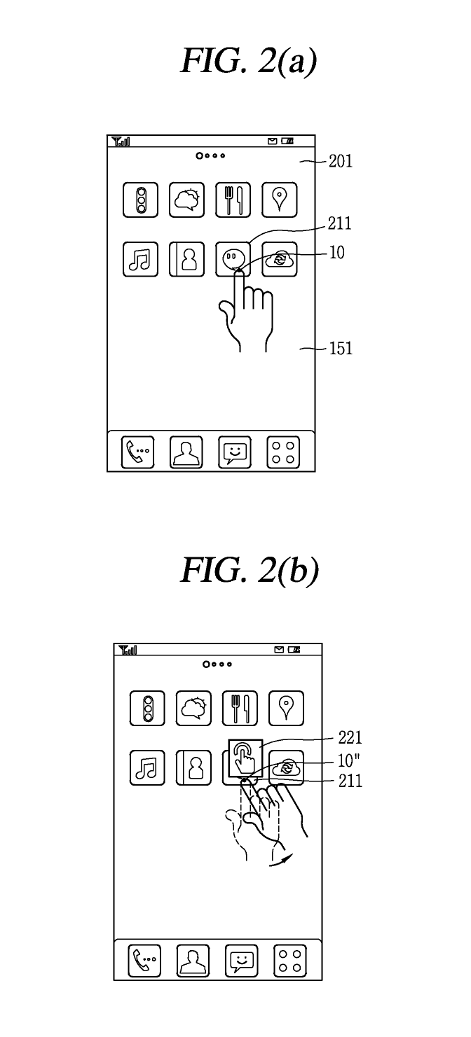

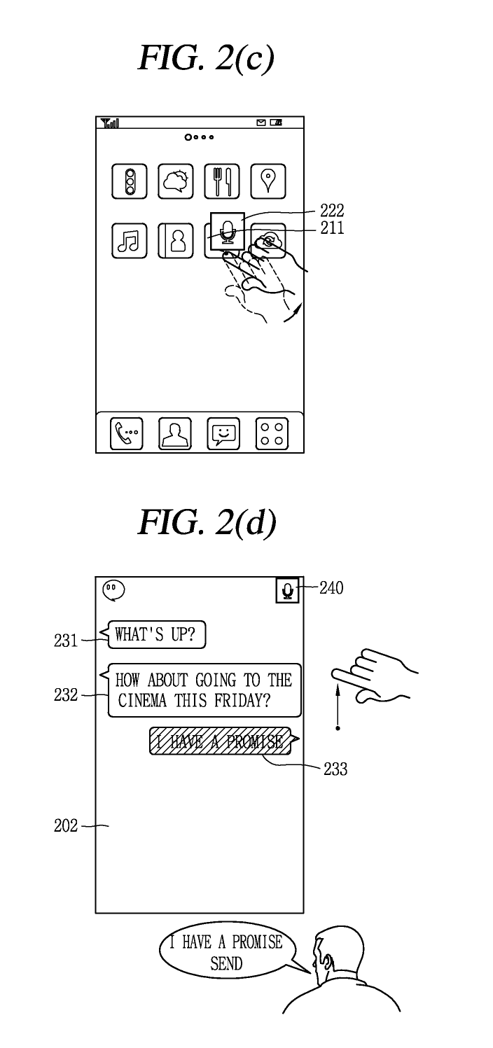

FIGS. 2(a) to 2(d) are conceptual views illustrating a representative operating method of a mobile terminal in accordance with one embodiment disclosed herein. First, as illustrated in FIG. 2(a), the display unit 151 of the mobile terminal 100 outputs a plurality of objects corresponding to a plurality of applications.

Here, the plurality of objects may be icons associated with respective applications installed in the mobile terminal 100 or folders or widgets in which those icons are grouped. Also, the plurality of objects may be output on a home screen 201, as illustrated in FIG. 2(a), or may be output on the display unit 151 which includes one of an idle screen and a menu screen.

Meanwhile, when the plurality of objects are icons associated with respective applications, each object, as illustrated in FIG. 2(a), may be implemented as an image icon 211 associated with the corresponding application. In addition, each of the objects may also be implemented as text which explains the application, in addition to the image related to the application. Here, each of the plurality of objects may include an image region and a text region.

In addition, even when one of the plurality of objects is a folder, similar to the aforementioned, the object may be implemented as only an image associated with the folder, or implemented in combination of an image associated with the folder and text explaining the folder. In such a manner, by using touch inputs applied to the plurality of objects, which are output on one of the idle screen, the home screen and the menu screen, user interfaces associated with the execution of corresponding applications can change (or switch). Also, the change of the user interface may not be performed, separate from an execution stage of an application. However, as will be explained in more detail later, an application may be executed as soon as a user selecting a desired user interface into which the user interface is to be switched.

Still referring to FIG. 2(a), after applying a touch input 10 to a specific object, for example, an icon 211 corresponding to a message function application, when a ‘pivot gesture input’ of rotating (or revolving) the applied touch input in a preset direction by a predetermined angle is sensed, the controller 180 executes an interface setting mode for changing a user interface associated with an execution of the application corresponding to the icon 211 from a touch-based user interface into another user interface.

Here, the ‘pivot gesture input’ is defined as a gesture using various movements of a finger(s) made without taking off the finger touching the display unit 151. The ‘pivot gesture input’ is distinguished from a drag touch input in that a touch input is stopped when at least part of an initial touch point is maintained. Also, the ‘pivot gesture input’ may be distinguished from a ‘long-press touch input’ in that a part of an initial touch point changes in size, pressure and the like in response to a movement of a finger. Also, the ‘pivot gesture input’ is a gesture of changing only a part of a touch point within a reference time after the touch is initially applied, and thus may be distinguished from the initially-applied touch input.

Also, the following description will be given on the assumption that the ‘pivot gesture input’ includes an initially-applied touch input. However, since the ‘pivot gesture input’ is distinguished from the initially-applied touch input in that a specific gesture is performed within a reference time after the initial touch is applied, the ‘pivot gesture input’ may be considered as a plurality of inputs including the initial single touch and the specific gesture.

Hereinafter, a state of the terminal, in which a user interface associated with an execution of an application corresponding to an object changes according to a user selection while the pivot gesture input is maintained, is referred to as ‘interface setting mode.’ When the interface setting mode is activated, the controller 180 controls a graphic object, which indicates another user interface to which the user interface is changeable (switchable), to overlap at least part of the object on which the ‘pivot gesture input’ is sensed or to be output near the object.

For example, as the graphic object indicating another changeable user interface, an image 221 indicating a gesture interface may be output by overlapping a part of the icon 211. The user who can thus recognize that the terminal has entered the ‘interface setting mode.’

Here, the graphic object is displayed, as illustrated in FIG. 2(b), in the form of an image (for example, a hand gesture image) 221, from which the user can intuitively recognize the changeable user interface, but may also be displayed in the form of text explaining the changeable user interface or a combination of the text and the image. Also, when the graphic object is output with obscuring at least part of the icon 211 as illustrated in FIG. 2(b), the graphic object may be output with a predetermined transparency, such that the user can recognize the obscured portion of the icon 211. Or, the graphic object may be displayed in the vicinity of the icon 211, or on a preset region of the display unit 151 (for example, an upper/central region of the display unit 151 to help the user's recognition).

In such a manner, when the ‘pivot gesture input’ 10″ is stopped while the image 221 indicating the gesture interface is output on the icon 211, that is, when a touch-up event is generated, the controller 180 selects the gesture interface corresponding to the output image 221 and also executes a message application corresponding to the icon 211. Afterwards, the controller 180 can display a chat screen on the display unit 151 through the gesture interface.

While the image 221 indicating the gesture interface overlaps the icon 211 as illustrated in FIG. 2(b), and when the ‘pivot gesture input’ rotates (revolves or moves) more by a predetermined angle, the image 221 indicating the gesture interface vanishes and another user interface, for example, an image 222 indicating a voice interface is output on the icon 211, as illustrated in FIG. 2(c).

Here, the controller 180 can distinguish the ‘pivot gesture input’ from other various touch inputs applied to the display unit, for example, a short touch input, a long-press touch input, a double touch input, a drag input, a tap, a flicking touch input and the like. Also, the controller 180 can sense or estimate at least one of a rotation (or rotating, revolving, moving) direction, a rotation degree (or a rotated degree (extent)), and a rotation speed (or a rotating speed) of the ‘pivot gesture input’ by virtue of the sensing unit 140.

Also, based on a touch point which is sensed at a time point that an image indicating another user interface is output in response to the ‘pivot gesture input’ (corresponding to a partially-changed initial touch point, so, hereinafter, referred to as ‘extended touch point’), the controller 180 can decide a degree of rotation (or an angle of rotation or a rotation (rotated) angle) for outputting an image indicating another user interface.

For example, when a finger rotates by a predetermined angle (for example, 15°to 20°) in a right-handed direction based on a touch point where the touch is initially applied to the icon 211, the interface setting mode is activated (entered) and the image 221 indicating the gesture interface is first output. Afterwards, when the finger rotates by a predetermined angle (for example, 20° to 35°) in the right-handed direction based on the extended touch point which is sensed at the time point that the image 221 is output, the image 221 changes into the image 222 indicating the voice interface.

In another embodiment, whenever the ‘pivot gesture input’ uniformly rotates (or uniformly moves) to exceed a predetermined angle based on the initial touch point, images indicating different user interfaces may be output in a sequential manner. This embodiment is different from the previous embodiment in that an image to be output is always decided according to a degree (extent) of rotation, which is sensed based on the initial touch point.

Meanwhile, user interfaces which are selectable by changing the movement (or the pivot) of the ‘pivot gesture input’ may include, for example, at least one of a gesture interface, a voice interface, an image interface and an eye-tracking interface. However, the ‘pivot gesture input’ may include any type of input manner, which allows for smooth interaction between the user and an execution of a specific application.

When the ‘pivot gesture input’ is stopped while the image 222 indicating the voice interface is output as illustrated in FIG. 2(c), namely, when a touch-up (touch release) event is generated, a message function application corresponding to the touch-applied icon 222 is executed. Accordingly, as illustrated in FIG. 2(d), the home screen 201 which has been output on the display unit 151 is switched into a message chat screen 202.

A notification icon 240 which notifies that the voice interface can be used may be output on one region, for example, an upper end region of the output message chat screen 202. Also, messages 231, 232 and 233 output on the message chat screen 202 may be output greater in size than those output on a touch-based message chat screen.

Here, by assuming that a distance between the user and the display unit 151 upon using the voice interface is longer than that upon using a touch-based interface, texts or images output on the display unit 151 may be output in an extended or larger size, so as to provide a more appropriate viewing (watching) environment for a user interface. Thus, the message chat screen 202 may be output in a larger size, instead of outputting an input region for writing messages. In another example, for this purpose, the message chat screen 202 may be output in a larger size, without outputting a region for touch-based icons and menus.

In order for the user to send a message on the message chat screen 202, the user can first input a voice message to send, and then say a specific control command, for example, ‘Send.’ In response, the input voice may be converted into a text form so as to be output on the message chat screen 202. For example, as illustrated in FIG. 2(d), if the user inputs a message ‘I have a promise’ using their voice and then says ‘Send’ after a predetermined time, the voice message ‘I have a promise’ is converted into a text form to be sent to another terminal, and then displayed as a message 233 on the chat screen 202.

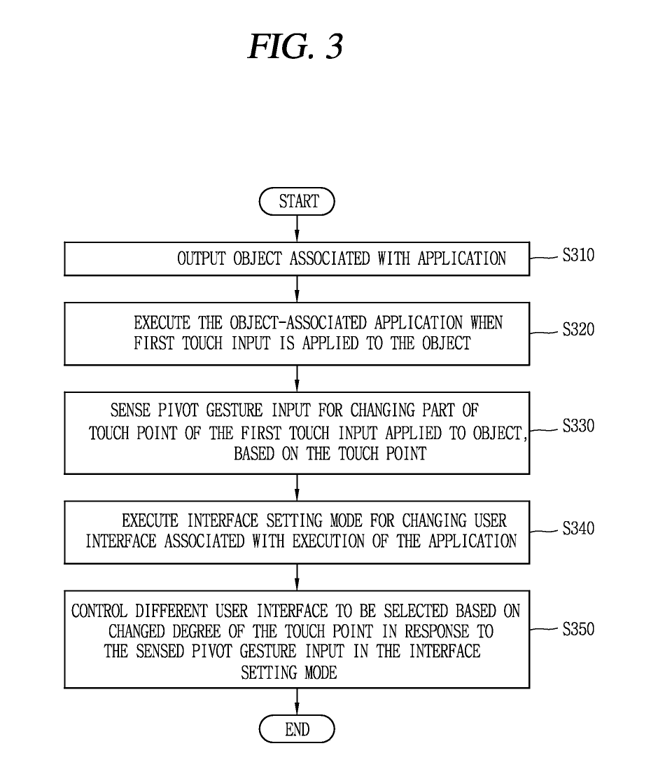

Next, FIG. 3 is a flowchart illustrating an operating method of a mobile terminal 100 in accordance with one embodiment disclosed herein. First, one or more objects related to at least one application may be displayed on the display unit 151 (S310). As discussed above, the object may be an icon associated with an application installed in the mobile terminal 100, or a folder or widget in which such icons are grouped.

When a first touch input is applied to at least one of the objects output on the display unit 151, the controller 180 executes an application associated with the object (S320). Here, the first touch input may be a single touch (or a tap touch) which lasts for a time shorter than a reference time. Further, the application may be executed at the moment when the first touch input is released. Hence, when the reference time elapses without the stop of the first touch input, another control command other than the execution of the application may be performed.

In more detail, before the lapse of the reference time when the single touch is applied to the output object, the sensing unit 140 can sense left/right/up/down movements of a touch object (or a touch tool, for example, a finger) which has applied the single touch. Here, the movement refers to moving the touch object for changing only a part of a touch point corresponding to the single touch without stopping the single touch.

When the sensing result is transferred from the sensing unit 140 to the controller 180, the controller 180 can recognize at least one of position, size and pressure of the touch point where the single touch has initially been sensed. The controller 180 can then determine whether or not the movement of the touch object which has applied the single touch corresponds to the ‘pivot gesture input,’ based on at least one of position, direction, number and changing speed of points (the touch point is assumed to be configured with a plurality of points), which have changed in view of at least one of the recognized position, size and pressure of the touch point.

After sensing the first touch input applied to the at least one of the objects output, the sensing unit 140 can sense a ‘pivot gesture input’ for changing a part of a touch point of the sensed first touch input, based on the touch point of the sensed first touch input (S330). When the ‘pivot gesture input’ is sensed, the controller 180 can activate an interface setting mode for changing (or switching) a user interface associated with an application corresponding to the object to which the first touch input has been applied (S340).

Further, the controller 180 can control the interface setting mode to be activated when the ‘pivot gesture input’ is sensed within a preset time after the first touch input applied to the object is sensed. In other words, after the lapse of the preset time when the first touch input applied to the object is sensed, the controller 180 can activate another function associated with the object, for example, an edit mode for changing at least one attribute information related to the object or an edit mode for moving or deleting the object. Thus, the controller 180 can count a time for which the touch point corresponding to the touch input applied to the object is maintained to be equal to the initial point (or within a preset range).

Upon the activation of the interface setting mode, an image indicating at least one another user interface selectable may be output to overlap the object or in the vicinity of the object. Accordingly, the user can recognize the entrance into the interface setting mode and what's the changeable user interface.

Meanwhile, the ‘pivot gesture input’ may be sensed by various methods. As illustrated in the embodiments of FIGS. 2(a) to 2(d) and 3, the ‘pivot gesture input’ which changes a part of the touch point may be sensed based on the sensed touch point. However, the ‘pivot gesture input’ may be sensed by sensing a movement direction, a movement angle and the like of a touch object (for example, a joint of a finger continued from a tip of the touched finger), which extends from the touch point, using a proximity sensor. Therefore, for the sake of explanation, the ‘pivot gesture input’ is illustrated as changing the part of the touch point based on the sensed touch point, but is not limited to this.

Also, when a ‘touch-up’ input is applied at the time point when the image indicating at least another user interface selectable is output, the controller 180 can output visual information (for example, a notification icon), which indicates that a user interface is selected, using the currently-output image on one region, namely, a lower end region of the display unit 151.

While the interface setting mode is activated, the controller 180 can allow a different user interface to be selectable, based on a changed extent (or degree) of the touch point of the touch input initially applied to the object in response to the ‘pivot gesture input.’ (S350).

For example, every time when the touch object, for example, the finger, which has been used to apply the initial touch input, rotates by a predetermined angle, images indicating different interfaces may be output in a preset order. Here, upon switching the rotating direction (moving direction or a rotation direction) of the touch object into an opposite direction while the initial touch input is maintained, the images indicating the different user interfaces may be output in the reverse order to the previously-output order. Also, when the angle of rotation exceeds a reference angle (for example, less than 0° based on the initial touch), the interface setting mode may be released and thus those images may not be output any more.

When the touch object which has applied the initial touch is in a touch-up state from the display unit 151 in any case, that is, when the ‘pivot gesture input’ is stopped, an application is executed through an interface corresponding to an image which has been output at the time point that the pivot gesture input has stopped.

As described above, according to one embodiment of the present invention, by using a touch input applied to an icon, a user interface associated with an execution of an application corresponding to the icon may be switched from a touch-based type into another type of user interface and simultaneously the corresponding application may be executed. In such a manner, for example, a single pivot gesture input may allow the user to achieve both of a selection of an interface desired to use and an execution of an application, without inconvenience of performing several steps for switching the user interface with respect to a specific application into a gesture.

The foregoing description has illustrated that selection of a user interface to change and an execution of an application are performed at the same time. Hereinafter, description will be given of a method of changing only a user interface of a specific application in advance without executing the application.

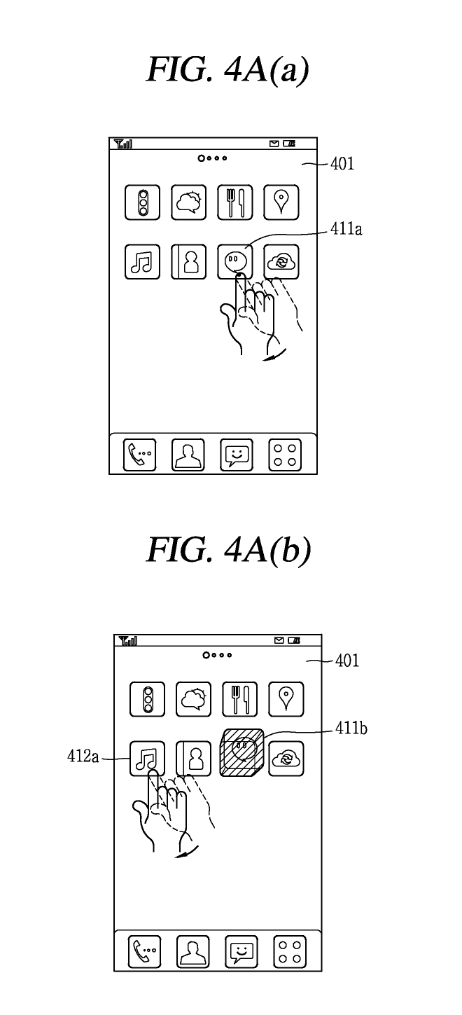

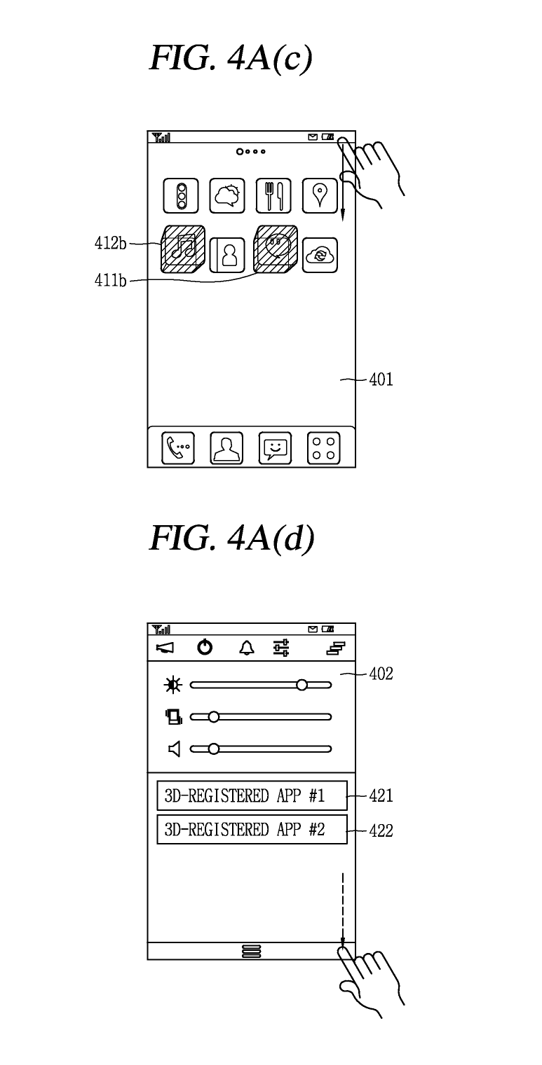

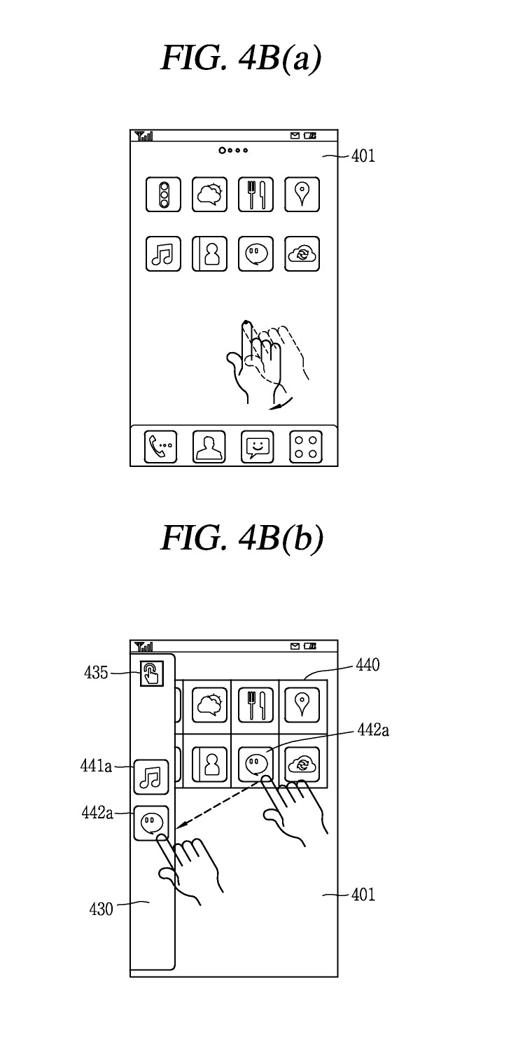

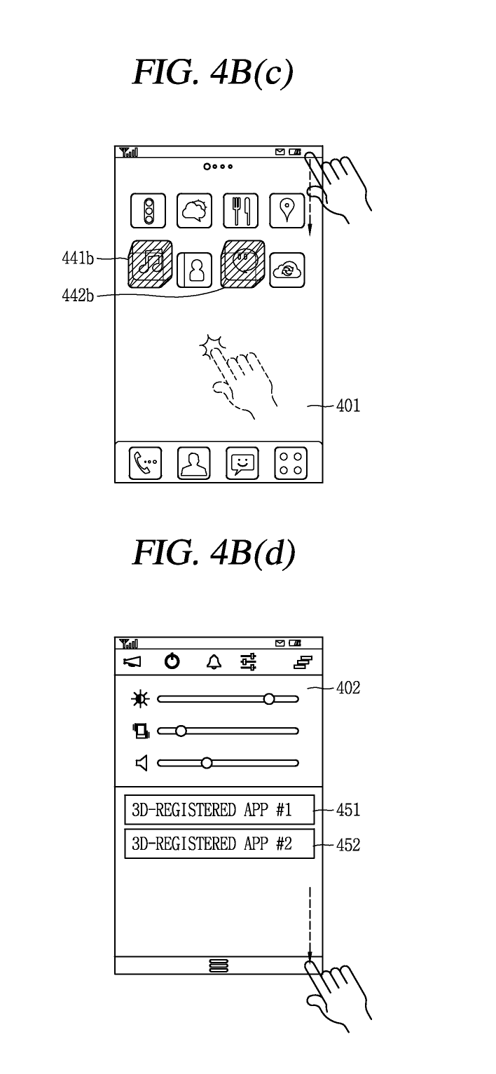

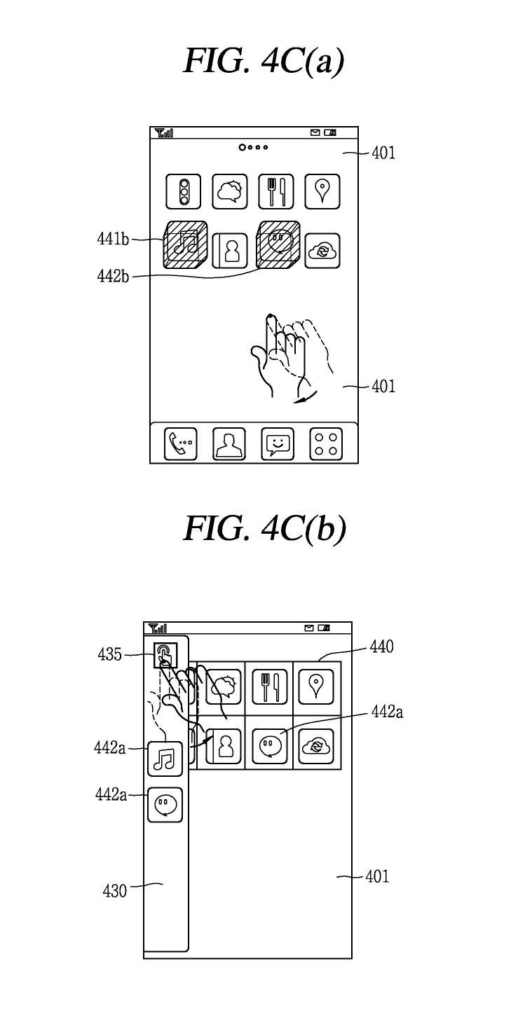

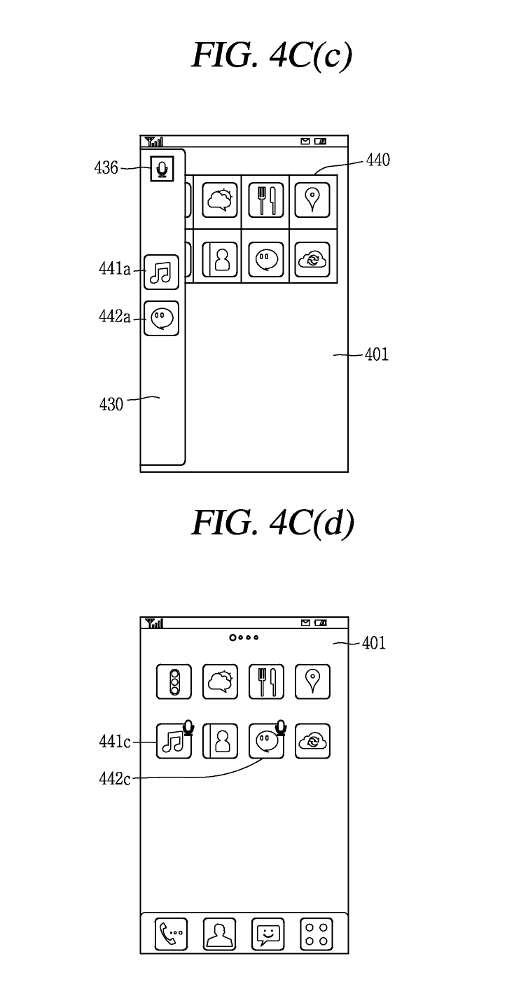

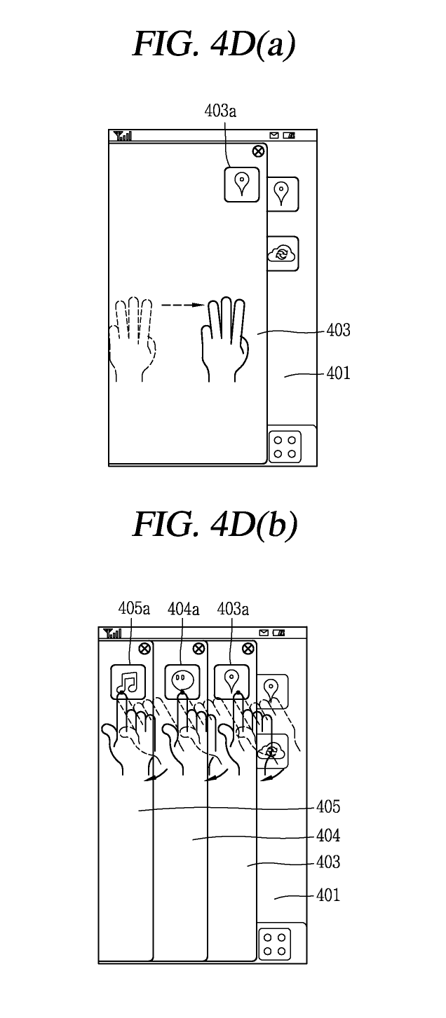

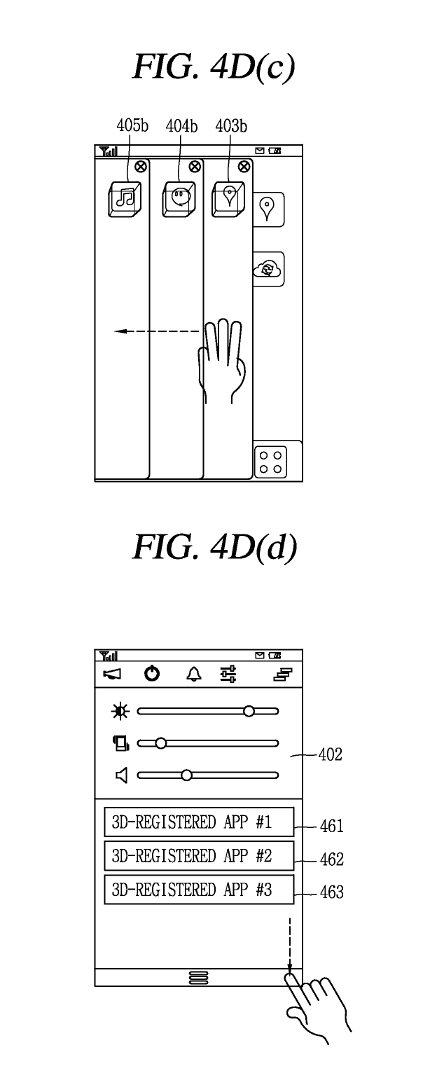

FIGS. 4A to 4D illustrate various methods of registering an application, to which a switched (changed) user interface is to be applied, in a mobile terminal in accordance with one embodiment disclosed herein. Even in this embodiment, the ‘pivot gesture input’ with respect to an icon of an application is also used. However, to distinguish from the embodiment in which the application is executed, the ‘pivot gesture input’ is referred to as ‘second pivot gesture input’ in this embodiment.

The ‘second pivot gesture input’ may be distinguished from the aforementioned ‘pivot gesture input,’ for example, in that the sensing unit 140 senses that a finger applying a touch to the display unit 151 rotates in an opposite direction to the aforementioned ‘pivot gesture input.’

First, FIGS. 4A(a) to 4A(d) illustrate a method of switching a user interface with respect to each application. For example, as illustrated in FIGS. 4A(a) to 4A(d), an interface setting mode corresponding to a ‘second pivot gesture input’ may be activated by rotating a finger, which has applied a first touch input to a specific icon 411a output on a home screen 401, within a reference time in a ‘left-handed direction (or an opposite direction to the aforementioned ‘pivot gesture input’) by a predetermined angle.

After sensing the first touch input applied to an object output on the display unit 151, when a changed extent of a point, on which the first touch input is sensed, exceeds a predetermined reference range, the controller 180 can differently switch a user interface associated with an execution of an application corresponding to the object.

Here, the controller 180 can preset or change a user interface, which is to change in response to the ‘second pivot gesture input,’ through a user input. The preset reference range may refer to a predetermined range of angle (for example, 0° to 45°). For example, after analyzing the changed extent of the sensed touch point of the first touch input, when it is sensed that the finger, which applied the touch input to the icon 411a illustrated in FIG. 4A(a), has rotated over 45° in the left-handed direction within the reference time, a user interface of an application corresponding to the touched object may be switched into another user interface (or a preset user interface).

The controller 180 can differently switch the user interface at a time point that the ‘second pivot gesture input’ is stopped, and display the object to be different from its previous form so as to be recognizable from the outside. In more detail, when the changed extent of the touch point of the first touch input exceeds the preset reference range in response to the ‘second pivot gesture input,’ the controller 180 can switch the object from a 2D image into a 3D image for output. In such a manner, with the object being output in the switched form (type), the user can recognize that the application corresponding to the object has been registered to be able to use another user interface, for example, a gesture interface.

For example, as illustrated in FIG. 4A(b), the icon 411a which has been output in the form of a 2D image may be switched into an icon 411b in the form of a 3D image. In addition to this, a notification icon (for example, a 3D interface) indicating that the user interface has changed may be popped up on one region, for example, a lower end region of the display unit 151 and then disappear.

Afterwards, when the ‘second pivot gesture input’ is stopped, the controller 180 can control an execution of an application corresponding to the icon 411b switched into the 3D image to be implemented by a 3D gesture. In this instance, the application is not executed at the time point that the ‘second pivot gesture input’ is stopped. Accordingly, as illustrated in FIG. 4A(c), the switching of a user interface for the next application may be continuously performed. Icon 412a can also be switched into 3D icon 412b as shown in FIG. 4A(c).

Also, when the application is registered to use the gesture interface, as illustrated in FIG. 4A(d), visual information 421 and 422, which notify the registration of the user interfaces of the applications may be output on a notification bar screen 402, which is output in response to a flicking touch input applied to an upper end region of the display unit 151. When a first touch input is applied to the object switched into the 3D image, the controller 180 can execute the application corresponding to the object through the gesture interface.

Next, FIGS. 4B and 4C illustrate a method of changing user interfaces of a plurality of applications through a registration screen. For example, as illustrated in FIG. 4B(a), while the home screen 401 with icons corresponding to applications displayed thereon is output, and when the ‘second pivot gesture input’ is applied to one point out of the icon-displayed region, the controller 180 can output on one region of the display unit 151 a registration screen for registering at least one application, to which a user interface associated with an execution of an application is applied after changed.

For example, a registration screen 430, as illustrated in FIG. 4B(b), may be output on one region, for example, a left region of the display unit 151 by gradually overlapping a part of the home screen 401. Most of the registration screen 430, as illustrated, may be implemented as an empty space such that at least one object can be moved thereto, and displayed with a different background color to be distinguished from the home screen 401. Also, as illustrated in FIG. 4B(b), an indicator icon 435 indicating a user interface (for example, gesture interface) to be changed may be displayed on one region, for example, an upper end region of the registration screen 430.

In such a manner, once the registration screen 430 is output, the controller 180 can switch the objects into a movable state so as to change positions of the objects arranged on the home screen 401 through a drag input. Accordingly, as illustrated in FIG. 4B(b), guide lines 440 may surround the objects such that the objects can be externally recognized as having changed into the movable state.

When the object is moved into the registration screen 430 in response to a drag input applied to the object after the object is converted into the movable state, the controller 180 changes and registers a user interface of an application associated with the moved object. That is, icons of a plurality of applications for which interfaces are to change may be moved into the registration screen 430 through a drag input, so as to fast change the user interfaces with respect to the plurality of applications. For example, as illustrated in FIG. 4B(b), an icon 441a of a music application and an icon 442a of a message function application may be dragged into the registration screen 430, so as to be registered as applications to which the gesture interface is applied.

Meanwhile, when a part of the object displayed on the home screen 401 is obscured by the registration screen 430, the user can check the obscured object by adjusting a left/right output range of the home screen 401 by sliding the home screen 401 to left or right. When the object is moved into the registration screen in response to the drag input applied to the object, the controller 180 can output notification information notifying the registration of an application associated with the moved object. The notification information may be output in the form of at least one of sound, vibration, message and graphic object, for example.

Meanwhile, when the touch input applied to the object on the registration screen 430 is dragged back into the home screen 401 and out of the registration screen 430, the controller 180 releases the registration of the corresponding application to which the gesture interface has been applied at the time point that the drag input is stopped. Here, the object dragged out of the registration screen 430 may be arranged on a drag-stopped point, and accordingly, the arrangement of the other objects may change.

As illustrated in FIG. 4B(c), when a single touch is sensed on one point of the home screen 401 out of the registration screen 430, the controller 180 moves each of the objects which has moved into the registration screen 430 to its originally-output position, and outputs an indicator indicating a changed user interface on the object, which has moved to its originally-output position. For example, the icons 441a and 442a which have moved into the registration screen 430 in FIG. 4B(b) may be converted from a 2D image into a 3D image and displayed in the form of the 3D image (441b and 442b).

In addition, icons corresponding to applications which have been registered through the registration screen 430 may be arranged by being separately collected on the home screen or displayed on a different page. When the application is registered to be able to use the gesture interface, as illustrated in FIG. 4B(d), visual information 451 and 452 notifying the registration of the user interfaces of the applications may be output on the notification bar screen 402, which is output in response to a flicking touch input applied to the upper end region of the display unit 151.

As illustrated in FIG. 4C(a) to 4C(d), when the ‘second pivot gesture input’ is re-applied on one point of the display unit 151, which is located out of a region where icons of applications are arranged, the registration screen 430 may be re-output on the part of the home screen 401, as illustrated in FIG. 4C(b). While the registration screen 430 is output on the display unit 151, when the ‘pivot gesture input’ is applied to the indicator icon 435 indicating the user interface (for example, the gesture interface) to change as illustrated in FIG. 4C(b), the user interface corresponding to the output indicator icon 435 is switched into another user interface (for example, a voice interface). Accordingly, as illustrated in FIG. 4C(c), the indicator icon 435 is converted into an image (for example, a microphone) 436 corresponding to the switched user interface.

In response to this, user interfaces of all the icons 441a and 442a moved into the registration screen 430 are switched from the gesture interface into the voice interface at once. As a result, when the registration screen 430 vanishes, as illustrated in FIG. 4C(d), the icons 441a and 442a which have moved into the registration screen 430 are displayed, on the home screen 401, in other indication forms (441c and 442c) (for example, a microphone image is output near each icon), other than in the form of the 3D-converted images.

In such a manner, the registration screen allows for fast selection of an application for which a user interface is to change, and also for the simultaneous change or addition, which will be explained later, of user interfaces for a plurality of applications.

FIG. 4D(a) to 4D(d) illustrate a method of changing user interfaces of multiple applications while the multiple applications are executed. As illustrated in FIG. 4D(a), when a multi-touch (for example, a three-finger touch) is applied to the display unit 151 in a specific direction, a specific application under execution or an application which the user frequently uses may be open or put aside.

For example, when three fingers touch a left region of the display unit 151 and then is dragged to the right, an execution screen 403 of the most-recently executed application is output by gradually overlapping a part of the home screen 401. In such a manner, as illustrated in FIG. 4D(b), execution screens 403, 404 and 405 of a plurality of applications which are being multitasked or frequently used may be output with overlapping a part of a previously-output execution screen.

Here, icon images 403a, 404a and 405a which indicate applications associated with the execution screens 403, 404 and 405 are displayed on one region, for example, right upper ends of the output execution screens 404, 404 and 405, respectively. In more detail, when the ‘second pivot gesture input’ is applied to each icon image 403a, 404a and 405a displayed, as illustrated in FIG. 4D(c), each icon image 403a, 404a and 405a may be converted from a 2D image into a 3D image 403b, 404b and 405b. That is, user interfaces of the applications corresponding to the execution screens 403, 404 and 405 may be switched from a touch-based type into a gesture-based type. In addition, when the home screen 401 is output on an entire region of the display unit 151 by putting aside the execution screens 403, 404 and 405 of the output applications to the left using a multi-touch (for example, touches with three fingers), the icons of the applications corresponding to the execution screens 403, 404 and 405 arranged on the home screen 401 may also be displayed in a converted state from the 2D images into the 3D images.

Also, when applications have been registered to be able to use such gesture interface, as illustrated in FIG. 4D(d), visual information 461, 462 and 463, which indicate the registration of the user interfaces of the applications, may be output on a notification bar screen 402 which is output in response to a flicking touch input applied to an upper end region of the display unit 151.

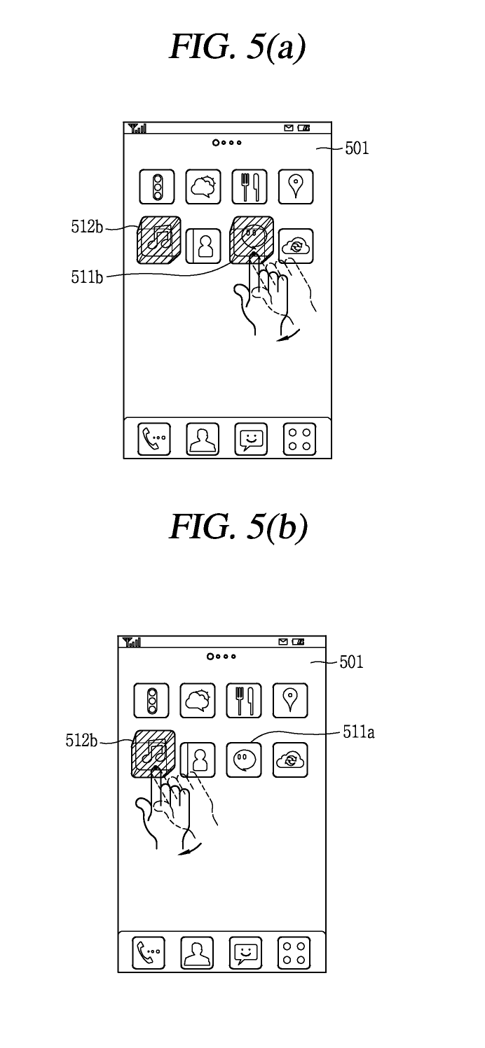

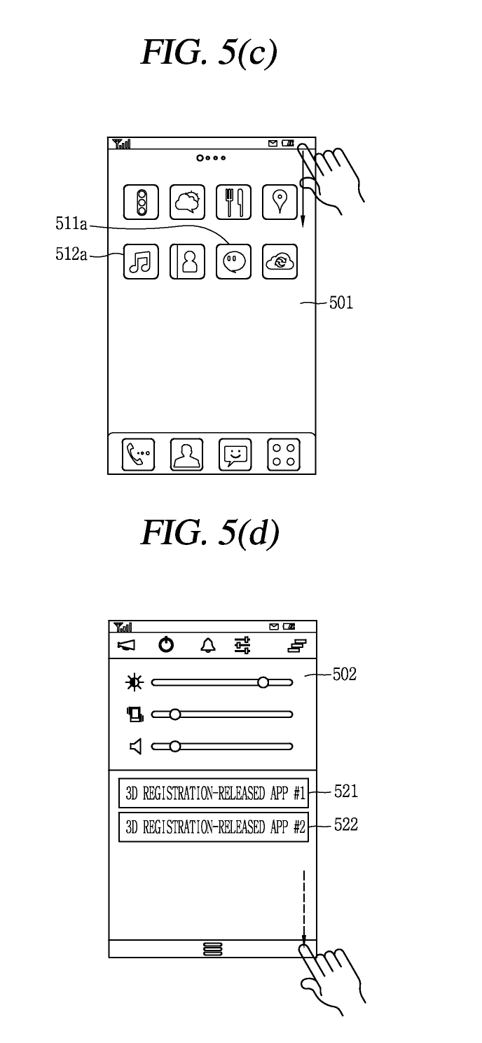

In addition, FIGS. 5(a) to 5(d) illustrate a method of releasing a registration of an application to which the switched user interface is applied, in a mobile terminal in accordance with one embodiment disclosed herein. Hereinafter, as aforementioned, description will be given on the assumption that an application is not executed at a time point of stopping a ‘pivot gesture input.’

When the ‘second pivot gesture input’ is sensed on an object corresponding to an application, the controller 180 applies an indication form, which indicates a user interface switched in response to the ‘second pivot gesture input,’ to the object. Accordingly, as illustrated in FIG. 5(a), icons corresponding to applications, which have been registered to use the gesture interface, may be displayed in the form of 3D images 511b and 512b, to be distinguishable from icons of other applications using touch-based interfaces.

Under this state, when the ‘pivot gesture input’ is applied to at least one of the icons 511b and 512b which have been converted into the 3D images, the controller 180 can control the switched user interface to be restored to its previous type and the indicator applied to the corresponding icon to vanish. That is, as illustrated in FIGS. 5(b) and 5(c), after applying touch inputs with a finger to the 3D-converted icons 51 lb and 512b, when the touched finger rotates within a reference time in one direction (for example, in a right-handed direction or in an opposite direction of the ‘second pivot gesture input’) by a predetermined angle, the user interfaces of the applications corresponding to the icons 511b and 512b are switched from the gesture-based type back into the touch-based type. As illustrated in FIG. 5(c), the 2D-converted icons 511a and 512a are thusly displayed on the home screen 501.

Also, when the registration of the application with the gesture interface applied is released, as illustrated in FIG. 5(d), visual information 521 and 522, which notify the user interface registration release of the applications, may be output on a notification bar screen 502, which is output in response to a flicking touch input applied to an upper end region of the display unit 151.

Meanwhile, when the ‘second pivot gesture input’ is applied to the icons (or icon images) 511a and 512a which have been converted back into the 2D images, the gesture interface is re-applied and the 2D-converted icon images 511a and 512a are converted back into the 3D icon images 511b and 512b. When a single touch is applied to the 2D icon images 511a and 512a or the 3D icon images 511b and 512b, an application corresponding to the icon is activated.

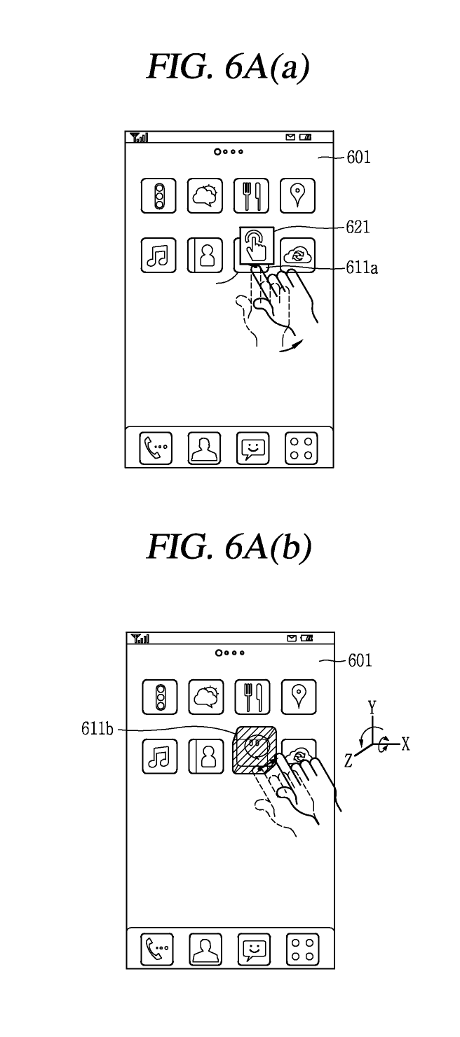

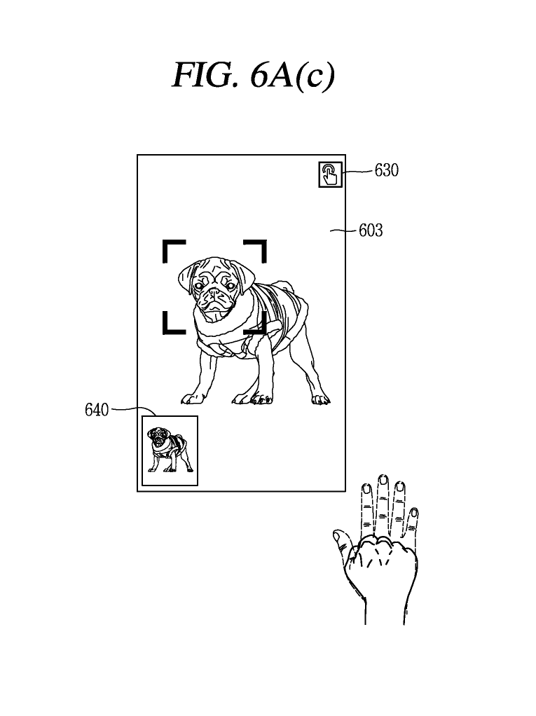

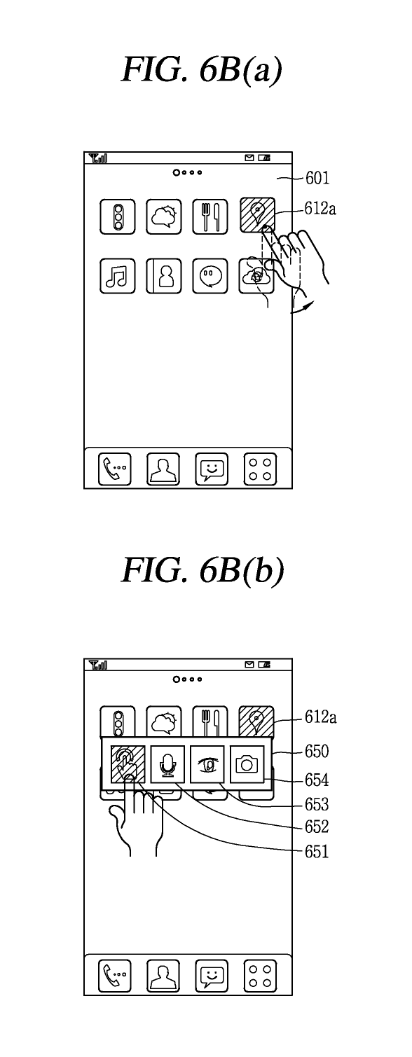

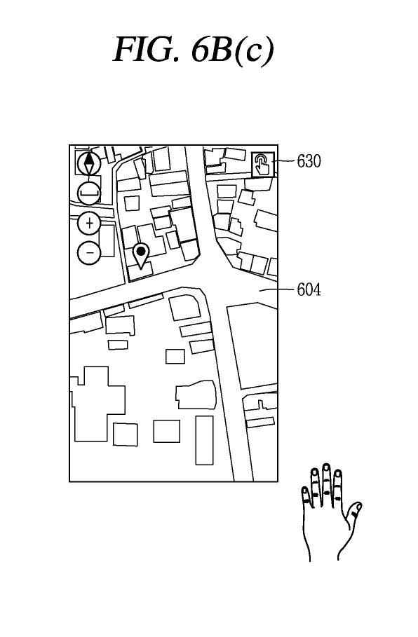

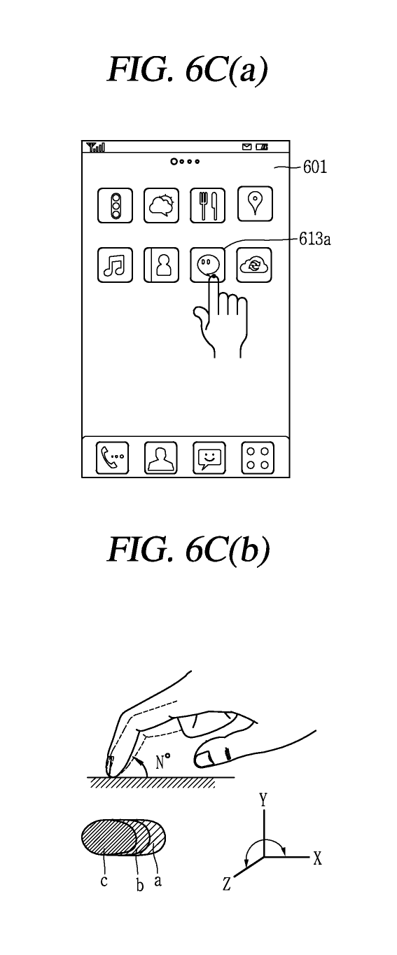

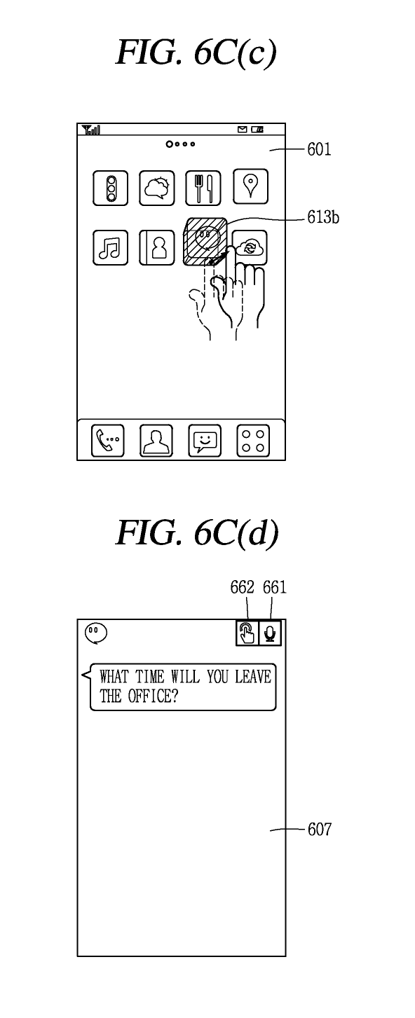

Hereinafter, description will be given in more detail of a method of selecting various user interfaces to change using touch inputs applied to icons of applications. FIGS. 6A to 6C illustrate various embodiments of selecting a user interface to switch (change) using a touch input applied to an icon of an application, in a mobile terminal in accordance with one embodiment disclosed herein.

While a single touch (i.e., a first touch input) is applied to an object associated with an application output on the display unit 151, and when the ‘pivot gesture input,’ which is applied based on the touch point for changing a part of a touch point corresponding to the first touch input, is sensed, an interface setting mode for changing a user interface of the application associated with the object, to which the first touch input has been applied, may be activated.

In the activated state of the interface setting mode, the controller 180 can control a different user interface to be selected based on an extent or degree that a part of the touch point corresponding to the first touch input gradually changes in response to the ‘pivot gesture input.’ Also, the controller 180 can control the display unit 151 to output a different graphic object corresponding to the different user interface.

Thus, the controller 180 can recognize a position, a size and pressure of the touch point corresponding to the first touch input within a reference time after the first touch input is sensed. The controller 180 can then determine whether or not a movement of a touch object which has applied the first touch input is the ‘pivot gesture input’ and also acquire information related to the ‘pivot gesture input,’ such as a rotating direction (for example, rotation to left or right, up or down based on the display unit 151), a degree of rotation (for example, a rotation angle), a rotating speed and the like, based on at least one of positions of points (the touch point is assumed to be configured with a plurality of points), on which at least one of the recognized position, size and pressure of the sensed touch point has changed, the number of the changed points, directions of the changed points and changing speed of the changed points.

For example, when the points on which the position and the pressure of the initial touch point have changed are mostly present on a left upper end and a right lower end and the size of the touch point has rarely changed, it can be noticed that the ‘pivot gesture input’ gradually rotates to right based on the display unit 151. Also, for example, when the points on which the position and the pressure of the initial touch point have changed are mostly present on a right upper end and a left lower end and the size of the touch point has rarely changed, it can be noticed that the ‘pivot gesture input’ gradually rotates to left based on the display unit 151. In another example, when the size of the initial touch point is gradually decreased and the points on which the pressure of the initial touch point has changed are mostly present on an upper end, it can be noticed that the ‘pivot gesture input’ gradually rotates upward (or erected) based on the display unit 151.

In such a manner, the controller 180 can recognize a rotation direction of the touch object, for example, the user's finger, which has performed pivoting (for example, left-right rotation or up-down rotation), a degree of rotation and a rotation speed, based on the changed extent of the touch point corresponding to the sensed pivot gesture input. Based on comparison results between those rotation direction, angle and speed and a preset reference direction, reference rotation angle and reference rotation speed, different control commands may be executed.

For example, as aforementioned, at the stopping time point of the pivot gesture input, whether to change and register only a user interface or to execute the application immediately with changing the user interface may be selected (determined). Also, while the pivot gesture input is sensed, the controller 180 can decide an included angle between a touch object (for example, a finger) applying a touch input and the display unit 151, based on a pattern that a region corresponding to a touch point of the touch input gradually changes. Also, the controller may accumulatively add other user interfaces to a user interface associated with an execution of an application or change the execution-related user interface into another user interface, based on the decided included angle.

When the user interfaces are accumulatively added based on the decided included angle, the controller 180 can differently change the number of another user interfaces added in response to an increase in the decided included angle, and accumulatively output graphic objects indicating the added another user interfaces on the display unit 151.

For example, when a pattern that a touch point corresponding to a touch input changes in response to a pivot gesture input matches a case where a touch object applying the touch input rotates to right by 15° three times, the controller 180 can accumulatively add three different user interfaces every time of the rotation by 15°. When a pattern that a touch point corresponding to a touch input changes in response to a pivot gesture input matches a case where a touch object applying the touch input rotates upward (i.e., erected) by 30° two times, the controller 180 can accumulatively add two different user interfaces every time of the rotation by 30°.

FIGS. 6A and 6B illustrate an embodiment of selecting a user interface to change by rotating a pivot gesture input ‘to the left or right’ and executing an application. Based on a pattern that at least one of a size of a region corresponding to a touch point, on which a first touch input is sensed, and pressure of the first touch input gradually changes in response to a pivot gesture input, the controller 180 can decide a direction and degree (or extent) that a touch object applying the first touch input rotates centering on the touch point.

Next, when the decided rotation direction matches a predetermined direction (for example, in a left/right direction), the controller 180 can differently change a user interface associated with an execution of an application based on the decided rotated degree. Afterwards, when the pivot gesture input is stopped, the controller 180 can apply an indicator, which indicates the user interface changed based on the rotated degree, to the graphic object.

For example, as illustrated in FIG. 6A(a), upon executing a ‘pivot gesture input’ using a finger which applies a touch input to a specific icon 611a displayed on a home screen 601, when the pivot gesture input rotates in a right direction and exceeds a reference angle (for example, 15°), an interface setting mode is activated. Accordingly, a graphic object 621 indicating a changeable (switchable) user interface (for example, a gesture interface) is output with overlapping at least part of the icon 611a.

After the output of the graphic object 621, when the ‘pivot gesture input rotates by more than a reference angle (for example, 30°) centering on the initial touch point, the controller 180 can switch the graphic object 621 into a graphic object which indicates another changeable user interface (for example, a voice, image or eye-tracking interface). The reference angle may be set or reset by a user input. For example, the reference angle may be set so a changeable user interface can change every time of rotating the pivot gesture input to right by 15°. Also, after the pivot gesture input rotates to right by 30°, when the pivot gesture input rotates to left by 15° by switching the rotation direction, an image of a previously-output user interface may be output again.

Meanwhile, when the rotation speed of the pivot gesture input is faster than a reference speed, the controller 180 can first output another user interface (for example, a voice, image or eye-tracking interface) without outputting the graphic object 621. Under this state, when the pivot gesture input is stopped, the controller 180 can control an application associated with the object to be executed and a screen control corresponding to the execution to be performed through the changed user interface.

As a method of outputting the changeable user interface on the object, the changeable user interface may be output one by one according to a rotated extent of the pivot gesture input. However, as illustrated in FIG. 6B(a) and 6B(b), when the pivot gesture input rotates over a reference range, a popup window 650 indicating a plurality of user interfaces selectable may also be output near the object.

Here, when a touch (for example, a single touch) is applied to a specific image 651 on the output popup window 650, the controller 180 changes the user interface into a user interface (for example, a gesture interface) corresponding to the touch-applied image 651, and executes an application at the touch-stopped time point. Accordingly, an execution screen 604 of a map application may be output, as illustrated in FIG. 6B(c).

As another example, when a continuous drag input is received while the pivot gesture touch input is maintained and then touched up (touch-released) on the specific image 651 within the output popup window 650, the controller 180 switches the user interface into the user interface (for example, a gesture interface) corresponding to the image 651 located on the touched-up region, and executes an application at the touch-stopped time point. Accordingly, the execution screen 604 of the application may be output, as illustrated in FIG. 6B(c).

That is, when the pivot gesture input is stopped in the activated state of the interface setting mode, the controller 180 can control the display unit 151 to output a plurality of graphic objects, which indicate different changeable user interfaces. Here, when at least one of the plurality of graphic objects output is selected, the controller 180 controls an application associated with the selected object to be executed at the graphic object-selected time point and a screen corresponding to the execution to be controlled (or adjusted) through a user interface corresponding to the selected graphic object.

When a pivot gesture input (the ‘second pivot gesture input) which has a rotation direction opposite to a predetermined direction is sensed with respect to a graphic object to which the indicator is applied (i.e., a graphic object indicating a changeable user interface), the controller 180 can restore the switched user interface to a previous user interface, and control the graphic object indicated on the object to be invisible.

Meanwhile, as illustrated in FIG. 6A(b), the controller 180 can control the screen corresponding to the execution of the application to be adjusted through the changed user interface, on the condition that a proximity touch is maintained for a preset time based on the stopped time point of the pivot gesture input or hovering is activated after the pivot gesture input is stopped in the activated state of the interface setting mode. Here, the hovering may be activated in a manner that the pivot gesture input is stopped with being spaced apart from the display unit 151 by a predetermined interval (for example, 5 mm to 10 mm) and thereafter when such state is maintained over a reference time, an electric field is generated to transfer to a touch channel of the display unit 151. That is, as illustrated in FIG. 6A(b), after applying the pivot gesture input by rotating the touch input applied to the display unit 151 in an X and/or Y-axial direction of the display unit 151, when the pivot gesture input is moved by a predetermined distance in a Z-axial direction, the hovering function is activated.

In such a manner, when the proximity touch is maintained for the preset time or the hovering is activated, the icon 611 a which has been output in the form of a 2D image is converted into the form of a 3D image 611b, as illustrated in FIG. 6A(b). When the pivot gesture input is completely stopped in the state that the image of the icon has been converted (meaning the time point that the proximity touch is stopped or the hovering is activated), a camera application corresponding to the icon is executed and the home screen 601 output on the display unit 151 is switched into a camera preview screen 603, as illustrated in FIG. 6A(c).

Here, an indicator icon 630 which indicates another user applicable interface (for example, a gesture interface) may be output on one region, for example, an upper right side of the preview screen 603. Also, an input key for executing capturing disappears from the preview screen 603 and capturing is started according to a user gesture (for example, a gesture of unfolding a palm of a hand toward the display unit 151 and then fisting it). Accordingly, a thumbnail 640 of a captured image may be output on one region (for example, a lower left side) of the display unit 151. As such, when the gesture interface is applied, touch-sensitive input keys may not be output on the display unit 151 any more, thereby providing an effect like an extension of a screen.

FIGS. 6C(a) to 6C(d) illustrate an embodiment of selecting a user interface to change by rotating a pivot gesture input ‘up and down’ and executing an application. For example, as illustrated in FIG. 6C(a) to 6C(d), while a single touch is applied to a specific icon 613a output on the home screen 601, when a pivot gesture input of erecting a finger in a Z-axial direction is performed within a reference time such that a part of the touch point sensed in the X and/or Y-axial direction based on the display unit 151 disappears, as illustrated in FIG. 6C(b), the user interface to change may differently be selected according to a rotated angle (or rotation angle) formed between the display unit 151 and the erected finger.

In more detail, as illustrated in FIG. 6C(b), when a region corresponding to an initial touch point is ‘a,’ the region ‘a’ decreases into regions ‘b’ and ‘c’ corresponding to the initial touch point as the rotated angle, namely, N° formed between the display unit 151 and the erected finger increases. Further, the touch pressure applied to the changed region increases as force is applied to a tip of the finger when the finger is erected.

As such, a different interface may be selected or accumulatively added according to the range of the rotation angle corresponding to N°. For example, a graphic object corresponding to a gesture interface may overlap an icon at N° in the range of 30 to 45°. A graphic object corresponding to a voice interface may overlap an icon at N° in the range of 45 to 60°. Also, a graphic object corresponding to an eye-tracking interface may overlap an icon at N° in the range of 60 to 75°, and a graphic object corresponding to an image interface may overlap an icon at N° in the range of 75 to 90°.

Meanwhile, as illustrated in FIG. 6C(c), the controller 180 can control the changed user interface to be selected on the condition that hovering is activated in a manner that the pivot gesture input of erecting a partial region of the touch input applied to the display unit 151 in the Z-axial direction of the display unit 151 and then the whole finger applying the pivot gesture input is moved away from the display unit 151 by a predetermined distance in the Z-axial direction. In this instance, the activation of the hovering may be recognized by the switching of an icon 613a in the form of a 2D image into an icon 613b in the form of a 3D image. When the activation of the hovering is set as a condition for applying an interface, a problem that an interface is changed due to a touch, which is similar to a pivot gesture input, unexpectedly applied by a user to an icon, can be prevented.

That is, when the pivot gesture input is stopped, as illustrated in FIG. 6C(d), an execution screen 607 of a message application corresponding to the icon 613a, on which the pivot gesture input has been sensed, is output on the display unit 151. Here, an input region for writing a message or an indicator icon indicating an operating state of the mobile tenninal 100 is not output on the execution screen 607 any more.

As aforementioned, a user interface of an application can be changed by one operation, thereby overcoming inconvenience which results from the user having to perform several steps for changing a user interface of a specific application into another user interface.

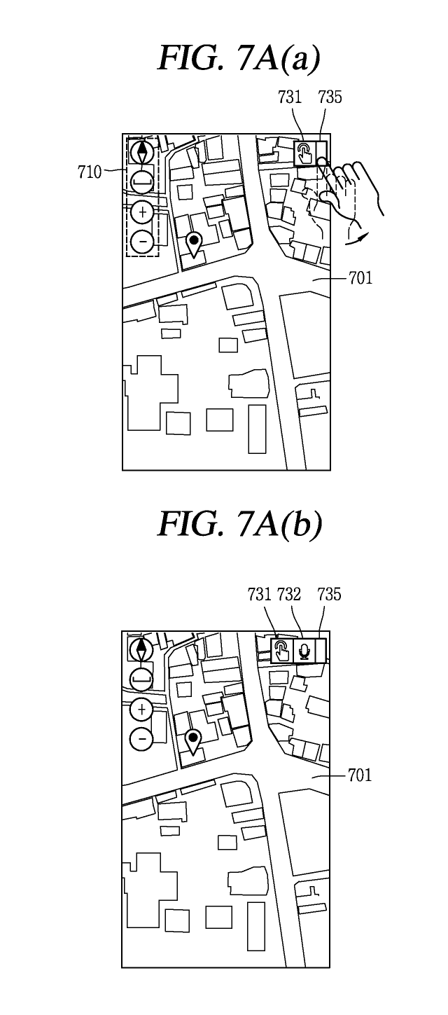

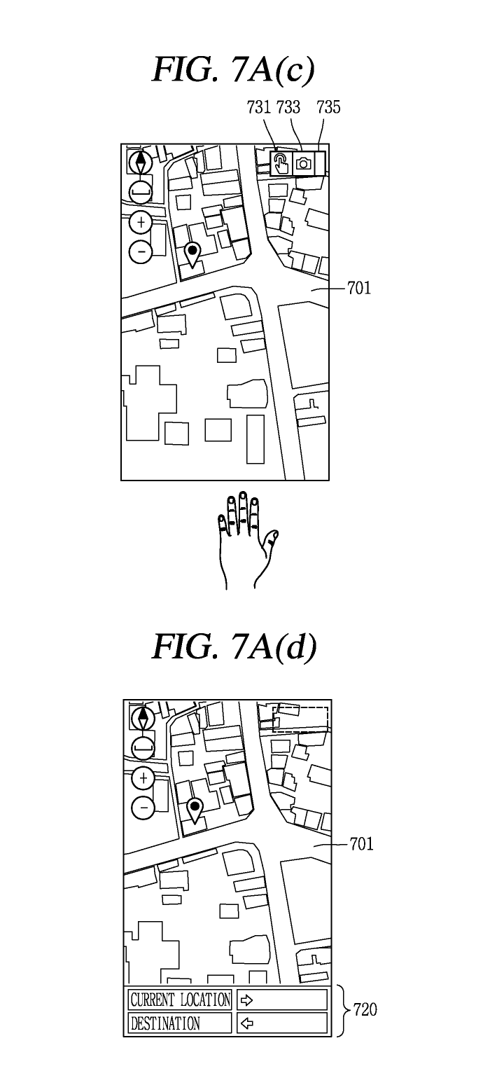

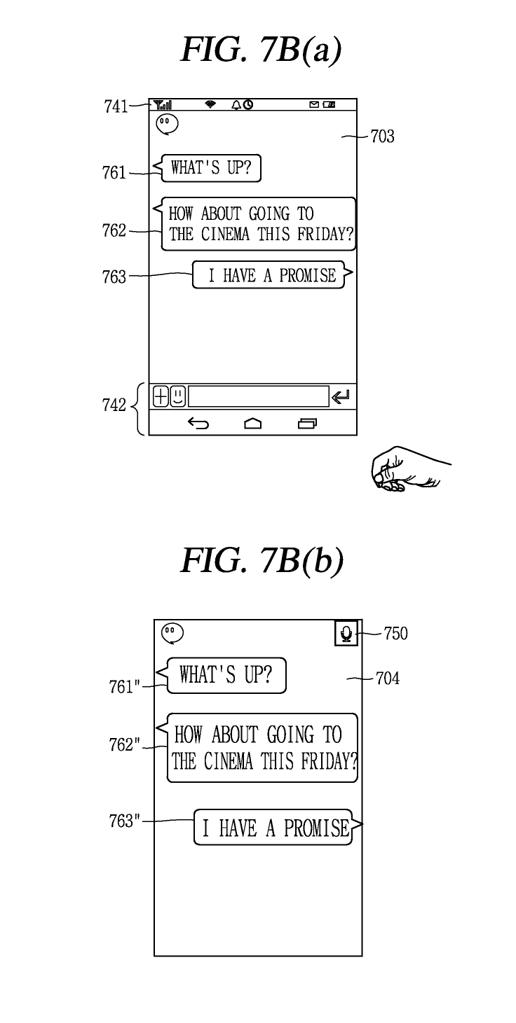

Next, FIGS. 7A and 7B illustrate a method of adding another user interface and a method of changing a configuration of a screen accordingly, while an execution screen of an application is output, in a mobile terminal in accordance with one embodiment disclosed herein. After a touch input applied to an object output on the display unit 151 is sensed, upon a release of a pivot gesture input for changing only a part of a touch point corresponding to the touch input based on the touch point, the controller 180 can execute an application by accumulatively adding other user interfaces to a user interface associated with an execution of the application.

FIG. 7A(a) illustrates an execution screen 701 of a map application to which a gesture interface is applied. An image object 731 notifying an applied user interface (for example, a gesture interface) is displayed on one region, for example, an upper right side of the execution screen 701, and an input region 735 is displayed adjacent to the image object 731. The pivot gesture input may also be sensed on the input region 735, and the input region 735 may be smaller than the image object 731 in size as illustrated.

Under this state, when the pivot gesture input is re-sensed on a predetermined region of the execution screen 701, the controller 180 can add another user interface to the user interface corresponding to the image object 731 notifying the applied user interface, or restore the user interface corresponding to the image object 731 into a user interface prior to being changed.

For example, after applying a touch input to the input region 735 with a finger, when the finger rotates to the right by more than a reference angle in a pivoted state on a touch point corresponding to the touch input, an image object 732 indicating a voice interface may be output and the input region 735 may be displayed adjacent to the image object 732. In this state, when the pivot gesture input is sensed on the image object 732 indicating the voice interface, as illustrated in FIG. 7A(c), an image object 733 indicating another image interface may be output on the region where the image object 732 indicating the voice interface has been output. Accordingly, it can be checked that the image interface, other than the voice interface, has been selected as an additional interface.

Meanwhile, when desiring to use only a touch-based interface on the execution screen 701, the pivot gesture input may be applied to one point of a map screen, which is out of the image objects 731 and 733 or the input region 735, thereby canceling every user interface added. Accordingly, as illustrated in FIG. 7A(d), the image objects 731 and 733 or the input region 735 may not be output any more, and a touch-sensitive input region (for example, starting point and destination input regions) may be re-displayed on one region, for example, a lower end of the display unit 151.

In this state, when a home screen is output on the display unit 151 due to a termination of the application corresponding to the execution screen 701, an indicator (for example, a 3D image icon) indicating the gesture interface may be continuously output on the icon of the application corresponding to the execution screen 701. That is, the cancelation of the user interface is applied only to the execution screen 701.

FIGS. 7B(a) and 7B(b) illustrate an embodiment of temporarily adding another user interface to a touch-sensitive execution screen of an application. In response to a first touch input being sensed with respect to an object, an application associated with the object may be executed using a touch-based interface. For example, as illustrated in FIG. 7B(a), a message chat screen corresponding to an execution of a message application may be output on the display unit 151.

Thus, when a preset gesture is sensed while an application without another user interface applied thereto is executed, the controller 180 can control a currently-output screen on the display unit 151 using a user interface corresponding to the sensed gesture. Here, the preset gesture is a gesture which is designated for temporarily controlling a currently-output screen on the display unit 151 using at least one of a hand gesture, an eye-tracking or an image. The preset gesture may be set or reset by a user input.

For example, as illustrated in FIG. 7B(a) and 7B(b), when a hand gesture, such as gripping a microphone with a hand and spreading the hand, is performed based on the display unit 151, a voice interface may temporarily be applied. Accordingly, an image object 750 indicating the applied voice interface may be output on one region, for example, on an upper right side of the display unit 151.

As another example, as illustrated in FIG. 7B(a) and 7B(b), when a hand gesture, such as gripping a microphone with a hand, is performed based on the display unit 151, a voice interface may temporarily be applied. Accordingly, an image object 750 indicating the applied voice interface may be output on one region, for example, on an upper right side of the display unit 151. The voice interface may be activated only while the hand gesture, such as gripping the microphone, is maintained, and automatically deactivated when the hand gesture is changed from the preset gesture into another gesture type.

Also, in this instance, the controller 180 can control a display region of an indicator indicating an operating state of the mobile terminal 100 to disappear from the currently-output screen on the display unit 151, such that the screen can extend. For example, as illustrated in FIG. 7B(b), the controller 180 can control a text font size of transmitted and received messages 761, 762 and 763 to increase (761″, 762″ and 763″) and a display region 741 of the indicator indicating the operating state of the mobile terminal 100 and a message input region 742 to disappear from the display unit 151.

In such a manner, when a user interface to apply is changed in one embodiment of the present disclosure, an output screen may be reconfigured to be appropriate for the change, thereby providing screen information suitable for a current interface environment. In addition, when an executed message application is closed, the touch-based interface is merely applied again in association with the execution of the corresponding application.

As described above, another user interface may be easily added or changed on a currently-output screen while an execution screen of an application is output, thereby providing user with convenience in use. This may allow for temporarily controlling a screen through a desired user interface even in case where an application is executed without adding or switching a user interface in advance.

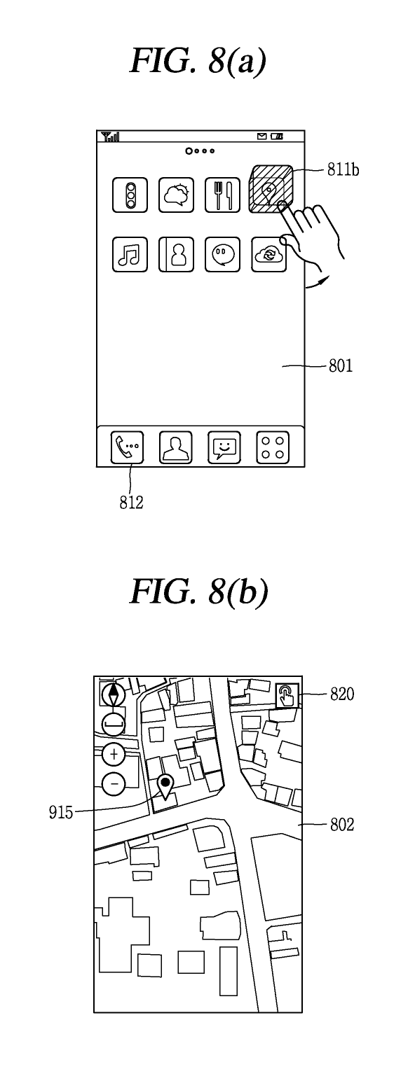

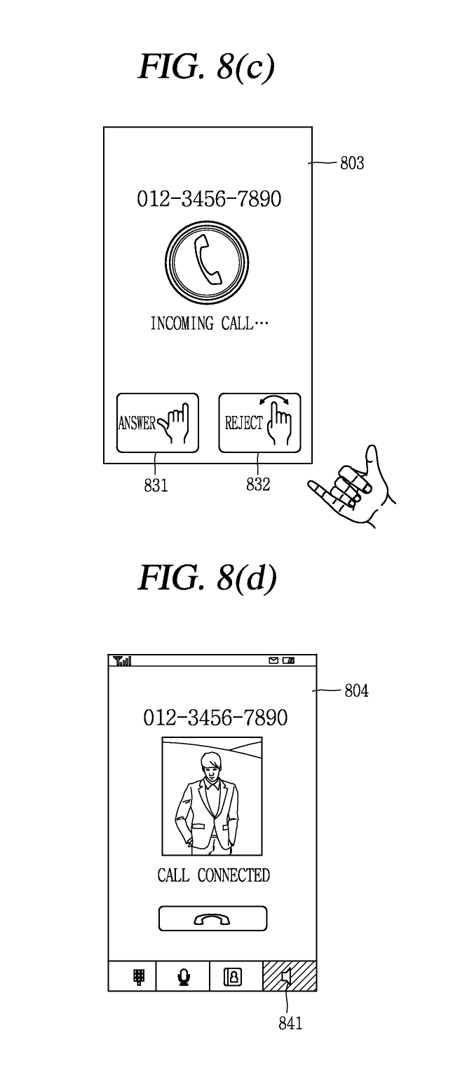

FIGS. 8(a) to 8(d) illustrate a method of processing an event generated in a touch-based application while an execution screen of an application to which a switched user interface is applied is output, in a mobile terminal in accordance with one embodiment disclosed herein.

The controller 180 can execute an application associated with an object, in response to a release of a pivot gesture input applied to the object associated with the application. When an event related to another application is received while the application is executed, the controller 180 can process the received event using a changed user interface.

The controller 180 can output guide information, which guides that the received event can be responded (processed) through the changed user interface, on one region of the display unit 151. For example, as illustrated in FIG. 8(a), when an icon 811b of a map application, which is indicated to apply a gesture interface thereto, and an icon 812 of a call application, which is indicated to apply only a touch-based interface thereto, are output on a home screen 801, when a first touch input applied to the icon 811b of the map application is sensed, a map screen 802 to which the gesture interface is applicable is output as illustrated in FIG. 8(b).

Here, when a call is received, as illustrated in FIG. 8(c), a call reception screen 803 is displayed, and also icons 831 and 832, on which a gesture for answering the call and a gesture for rejecting the call are indicated as guide information, are displayed on a lower end of the call reception screen 803. When the user performs the gesture for answering the call, the call is connected. Accordingly, a speaker icon 841 is automatically selected as illustrated in FIG. 8(d), such that a speaker function is maintained in an active state while the call is connected. Meanwhile, when the user performs a hand gesture of unfolding only a fifth finger with the other fingers folded, such as making a ‘promise,’ the received call may be rejected and also a message (for example, ‘Call you later’) may automatically be sent to a caller's terminal.

Also, while a first application is executed through a specific interface, when a notification (for example, a call reception, a message reception, etc.) is received from a second application, the controller 180 can control the second application to be executed through an interface associated with the specific interface of the first application, such that the notification from the second application can be checked or responded . For example, the second application may be controlled to be executed through the same interface as that of the first application. As another example, when the second application is being executed through a specific interface different from a touch-based user interface, the second application may be controlled to be always executed through a preset interface (for example, a gesture interface).

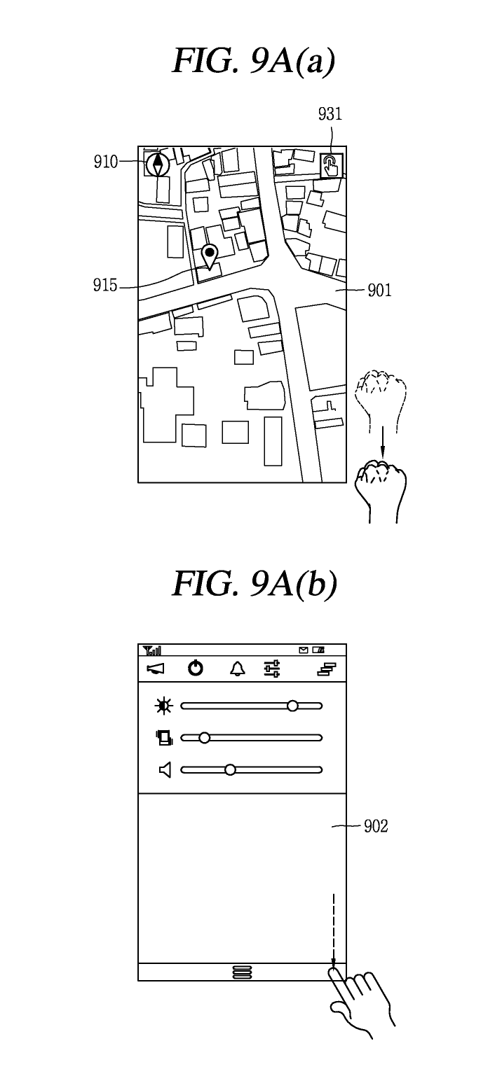

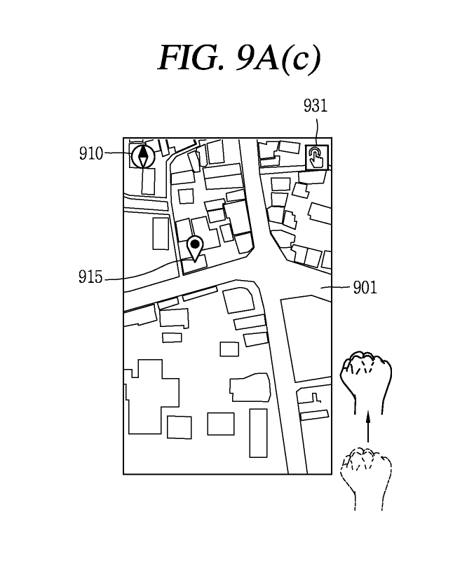

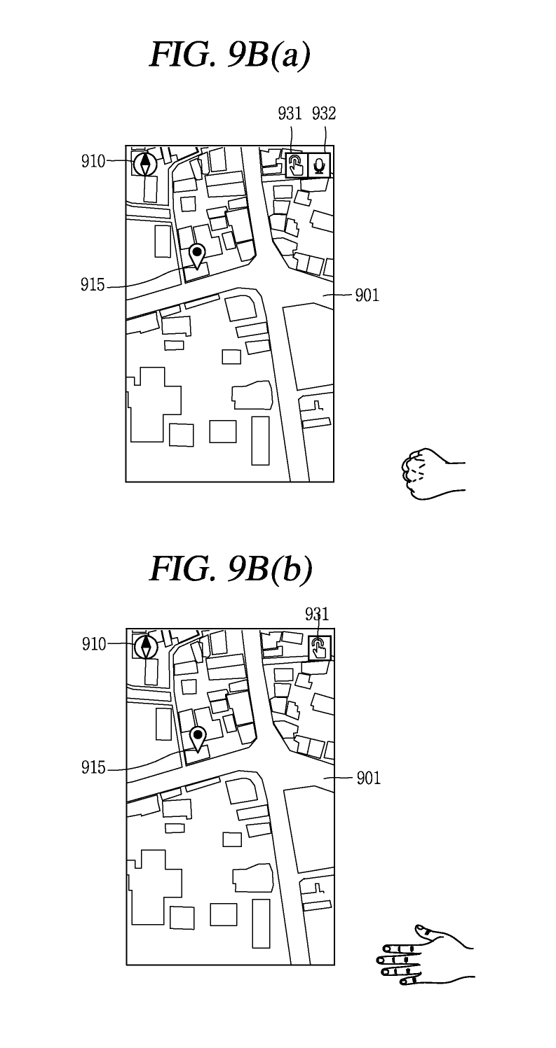

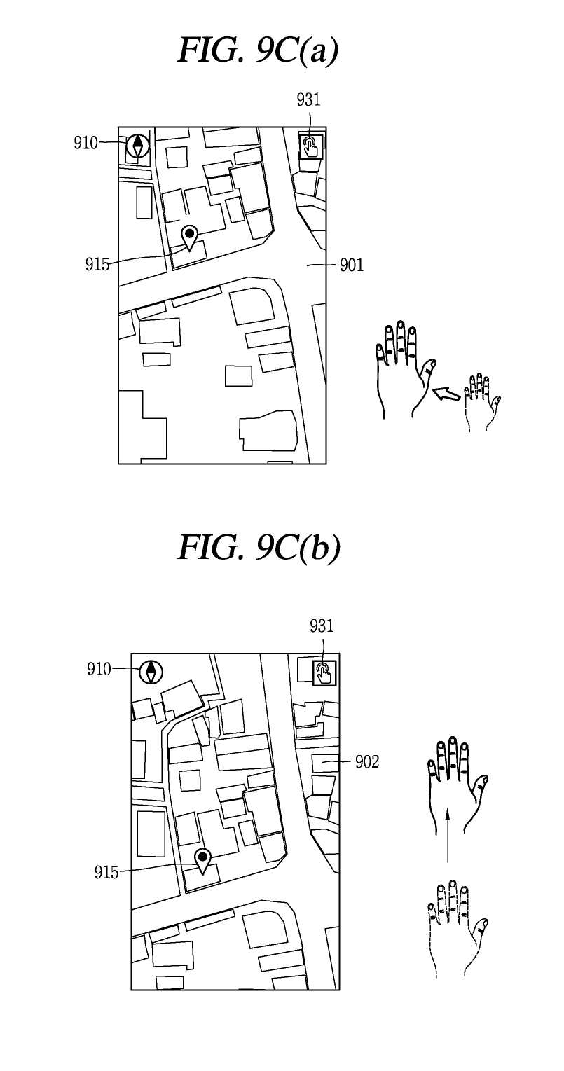

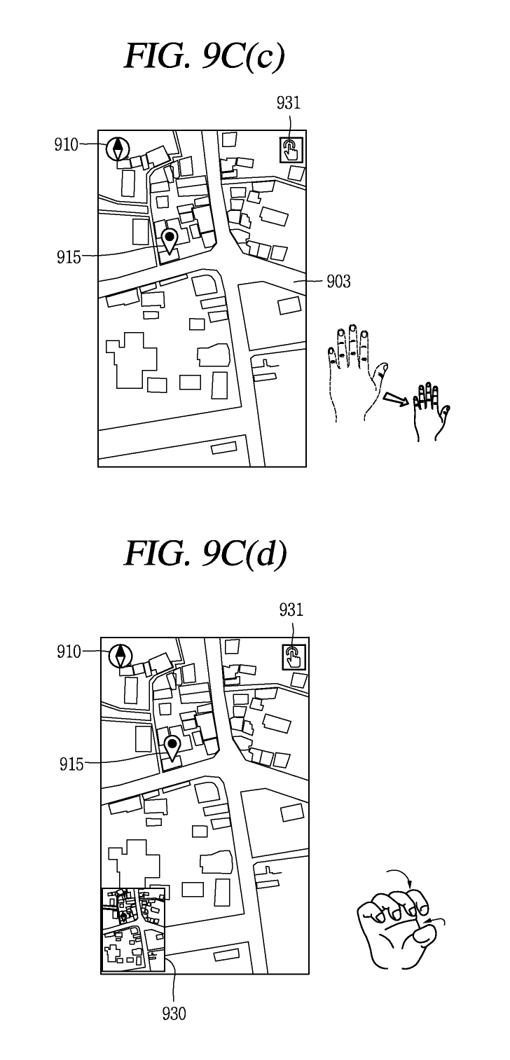

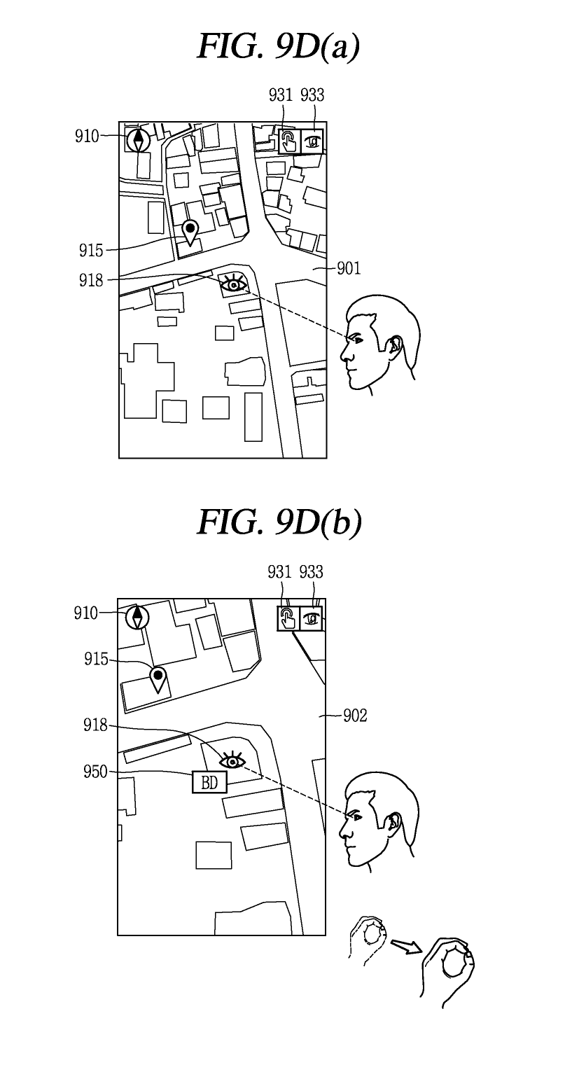

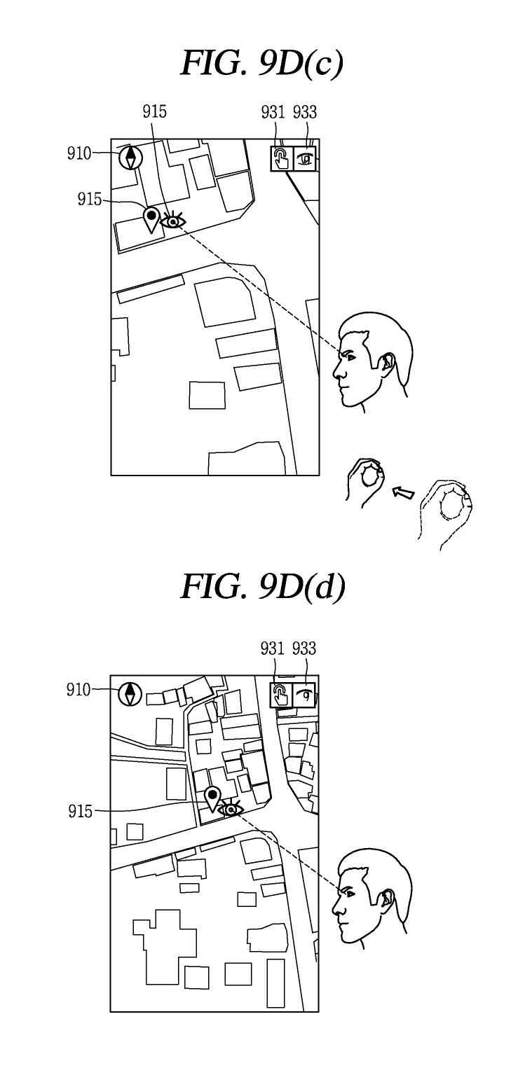

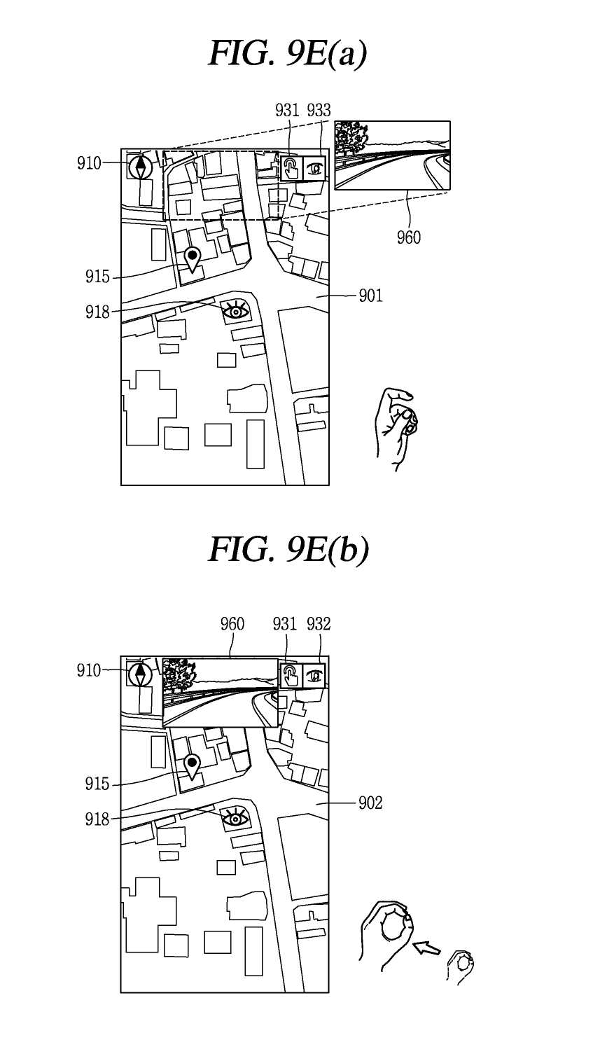

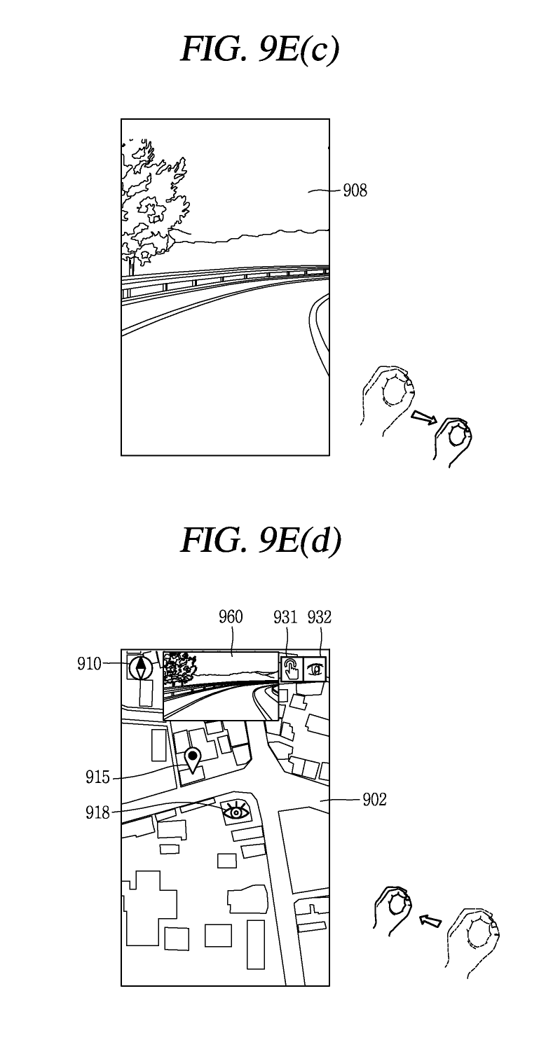

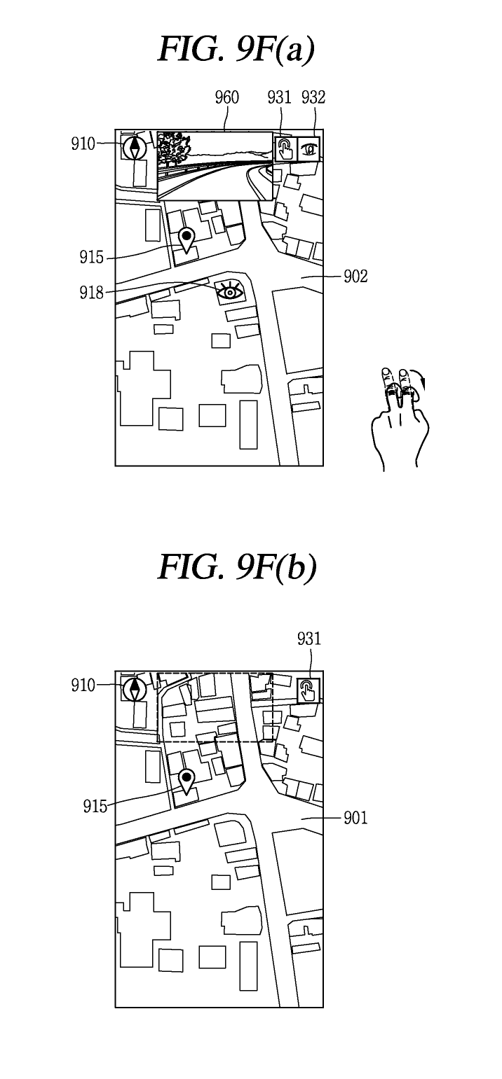

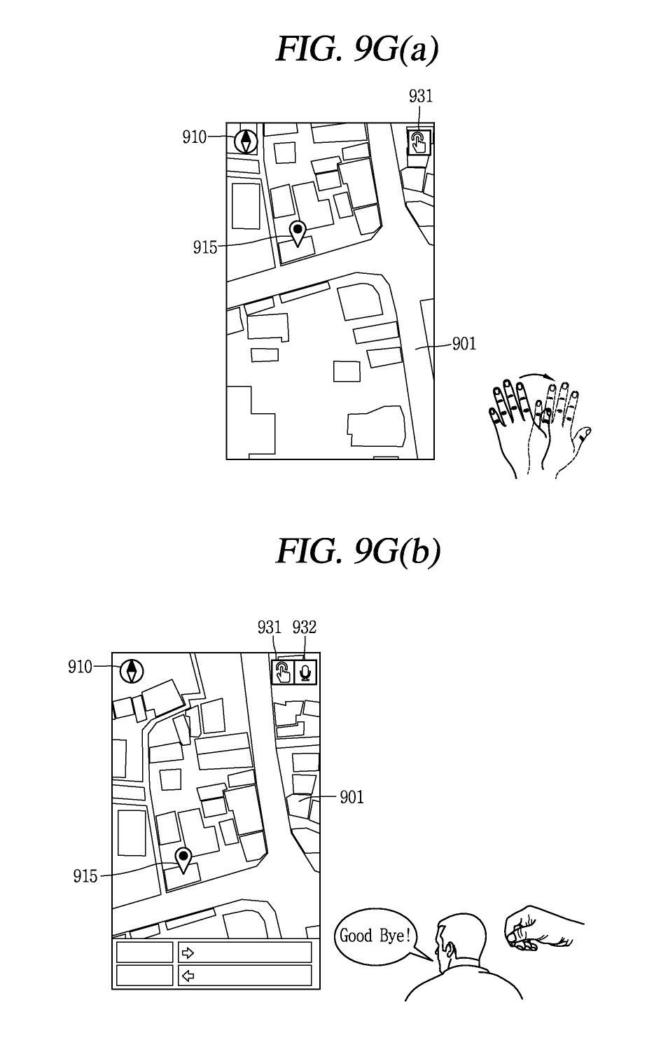

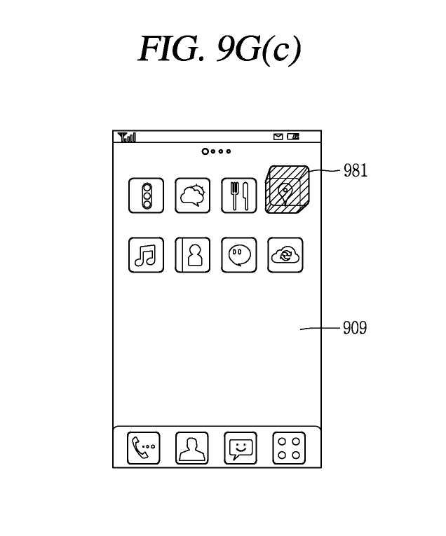

FIGS. 9A to 9G illustrate detailed gestures for controlling an execution screen of an application using a gesture interface, in a mobile terminal in accordance with one embodiment disclosed herein. First, as illustrated in FIG. 9A(a), an image object 931 indicating a gesture interface being applied is output on an upper right side of a map screen 901 to which a gesture interface has been applied, and an image object 910 indicating orientation information is output on an upper left side of the map screen 901. In this state, when a user performs a gesture of pulling a first from up to down, as illustrated in FIG. 9A(a) and (b), a notification bar screen 902 indicating an operating state of the mobile terminal and a generated event is output. In this state, when the user performs a gesture of pulling up a fist, as illustrated in (c) of FIG. 9A, the output notification bar screen 902 disappears like being pulled up and then the map screen 901 is output again.

As another example, as illustrated in FIG. 9B(a), when the user performs a hand gesture of making a first like gripping a microphone, a voice interface is added. Accordingly, an image object 932 indicating the added voice interface is output adjacent to the image object 931 indicating the gesture interface. Here, when the user unclenches the fist, as illustrated in FIG. 9B(b), the output image object 932 indicating the voice interface disappears and the gesture interface is merely applied.

FIGS. 9C(a) to 9C(d) illustrate a gesture of zooming in, zooming out and moving the map screen 901 using a gesture. As illustrated in FIG. 9C(a), when the user performs a gesture of approaching a palm of a hand to the display unit 151, the map screen 901 is zoomed in proportional to an approached distance (902). When the palm is moved to the left, to right, up or down on the same line based on the display unit 151, as illustrated in FIG. 9C(b), an output range of the map screen 901 is moved to the left, to right, up or down. Also, as illustrated in FIG. 9C(c), when the user performs a gesture of getting the palm away from the display unit 151, the map screen 901 is zoomed out proportional to the distance got away from the display unit 151 (903). Also, when performing a gesture of folding only tips of five fingers with leaving the palm open toward the display unit 151, a map screen 901 currently output on the display unit 151 is captured.

FIGS. 9D(a) to 9D(d) illustrate an embodiment of controlling the map screen 901 using a gesture and an eye-tracking interface. As illustrated in FIG. 9D(a), when the user performs a hand gesture, such as looking through a telescope, a camera 122 provided at the mobile terminal 100 is activated so as to track the user's eye. And, an output range of the map screen 901 may change such that the user's eye is located at a center of the map screen 901. Here, as illustrated in FIG. 9D(a), an eye image 918 which moves along the user's eye may be displayed on the map screen 901, and detailed information (for example, an address, a name of a building, POI information, etc.) 950 related to objects located adjacent to the eye image 918 may be displayed. Also, as illustrated in FIG. 9D(b) and 9D(c), with maintaining the hand gesture, such as looking through the telescope, the hand may move back and forth, so as to zoom in or out the map screen 901 based on a fixed position of the user's eye, as illustrated in FIG. 9D(c) and 9D(d).

As illustrated in FIGS. 9E(a) to 9E(d), while the eye-tracking interface is activated as illustrated in FIG. 9D, when the user performs a hand gesture like pressing a camera shutter as illustrated in FIG. 9E(a), a road view image 960 of the fixed position of the user's eye is output on one region, for example, on an upper center of the display unit 151. The road view image 960 may be a pre-stored image, or a real-time image.

Under this state, when the user moves the hand back and forth with maintaining the hand gesture like looking through the telescope, as illustrated in FIG. 9E(b) to 9E(d), the road view image 960 is output on an entire region of the display unit 151 (908) or restored to its original state. While the road view image 960 of the fixed position of the user's eye is output, when the user performs a hand gesture like pressing a shutter with two fingers as illustrated in FIG. 9F(a), the output road view image 960 disappears as illustrated in FIG. 9F(b).

FIGS. 9G(a) to 9G(c) illustrate a gesture of closing an application which is being executed using a gesture interface. For example, when the user performs a gesture of shaking a hand to the left and right like making a gesture of ‘hello’ as illustrated in FIG. 9G(a), or adds a voice interface by making a first like gripping a microphone and inputs a voice command, such as ‘Good bye’ as illustrated in FIG. 9G(b), the map application under execution may be terminated and accordingly a home screen 909 may be output on the display unit 151 as illustrated in FIG. 9G(c).

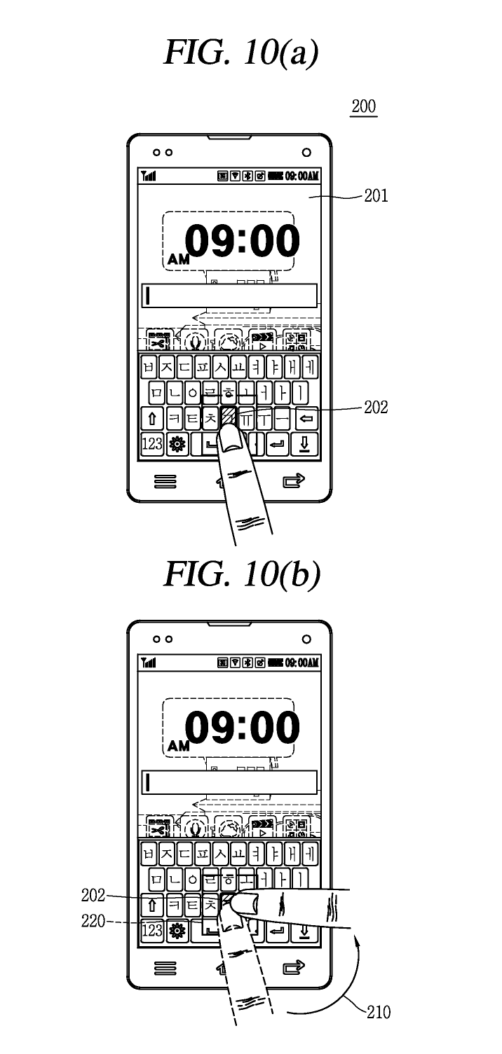

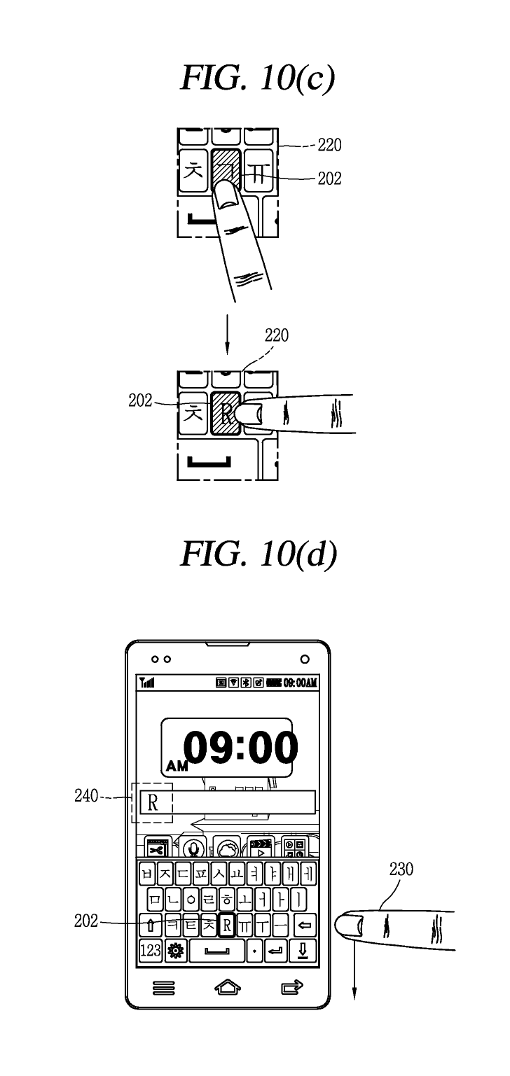

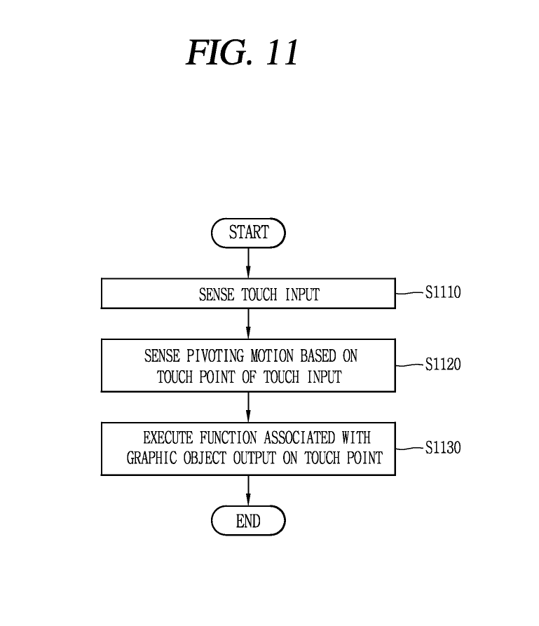

Hereinafter, description will be given of a novel UI or UX which uses movements of a finger after applying a touch input to a touch pad of the mobile terminal. FIGS. 10(a) to 10(d) illustrate one embodiment of performing a specific function of a mobile terminal by sensing a movement of a touch object (or a touch tool) after a touch input is applied, and FIG. 11 illustrates a control method of a mobile terminal in relation to the one embodiment.

As illustrated in FIGS. 10(a) to 10(d), a display unit 201 of a mobile terminal 200 may include a sensing unit 140 for sensing a plurality of inputs including a user's touch input T. A controller 180 of the mobile terminal 200 may perform preset functions in response to the plurality of inputs sensed. When the touch input T is sensed and then a pivot gesture P applied based on a touch point corresponding to the touch input T is sensed, the controller 180 can perform a function associated with a graphic object 202 output on the touch point.

In more detail, as illustrated in FIG. 10(a), the sensing unit 140 may sense a touch input T applied to a specific key 202 of a virtual keyboard output on the display unit 201. For example, the specific key 202 may be a virtual keyboard key with respect to a Korean character ‘ [symbol] .’

Next, as illustrated in FIG. 10(b), the controller 180 can sense a movement 210 of a touch object based on the touch point of the touch input T after the touch input T is applied. In this invention, the movement 210 of the touch object based on the touch point is defined as “pivot gesture” (hereinafter, refer to description in relation to FIG. 11). That is, the controller 180 can sense the pivot gesture 210 applied based on the touch point, following the touch input T applied.

Herein, FIG. 10(c) illustrates an enlarged state of one region 220 of the display unit 201 which includes the graphic object 202 on which the touch input T and the pivot gesture 210 have been sensed. As illustrated in FIGS. 10(b) and (c), when the pivot gesture is sensed, the controller 180 can perform a function associated with the graphic object 202 output on the touch point.

In more detail, when the graphic object 202 has a specific key, the controller 180 can switch a character (first character) set for the specific key into another character (second character) using the pivot gesture 210. For example, the first and second characters may be output on the same position of the virtual keyboard. When a key switching button of the virtual keyboard is input, the controller 180 can perform switching between the first and second characters for output. Accordingly, the user can apply the pivot gesture 210 to the first character, so as to switch the first character into the second character even without a reception of the key switching button input.

For example, when the character “ [symbol] ” is preset on the graphic object 202, the controller 180 can switch the character set on the graphic object 202 into “R” using the pivot gesture 210. The controller 180 can also select one of one or more other characters and switch the character set on the graphic object 202 into the selected one using the pivot gesture 210. Here, the controller 180 can output a guide image indicating the one or more other characters on one end of the graphic object 202.

As illustrated in FIG. 10(d), after the pivot gesture 210 is applied, when the touch is released, the controller 180 can input the switched character into an input window 240 displayed on the display unit 201. For example, as illustrated in FIGS. 10(a) to 10(d), when the character set on the key of the graphic object 202 is switched from “ [symbol] ” into “R,” the controller 180 can input the character “R” onto the input window 240, in response to the release 230 of the touch input after the pivot gesture 210 is applied.

In this instance, the controller 180 can maintain the state that the character “R” has been set for the key of the graphic object 202. In addition, when a predetermined time elapses after the switched character “R” is input to the input window 240, the character set for the graphic object 202 may be switched back into the character “ [symbol] .”

FIG. 11 illustrates a control method of the mobile terminal in relation to the one embodiment illustrated in FIGS. 10(a) to 10(d). According to the control method for a mobile terminal disclosed herein, the sensing unit may sense a touch input (S1110), and the controller 180 can sense a pivot gesture based on a touch point corresponding to the touch input (S1120). Accordingly, the controller 180 can sense the pivot gesture, which is distinguishable from a touch, a long touch, a drag, a flicking and a tap with respect to a touch pad. Also, the controller 180 can also sense attribute information related to the pivot gesture as well as whether or not the pivot gesture has been applied. For example, the attribute information may include a direction and a speed of the pivot gesture.

The controller 180 can then perform a function associated with a graphic object output on the touch point (S1130). The graphic object output on the touch point may occupy a predetermined region of the display unit including the touch point or may be an image displayed on the entire display unit.

According to the mobile terminal and the control method thereof disclosed herein, the user can control an activation of various functions of the mobile terminal using a movement of a finger which is applied after applying a touch input. This may allow for extension of an operation range of the terminal. Also, the number of touch inputs which are required to the user for performing a specific function can be reduced, thereby enhancing user convenience.

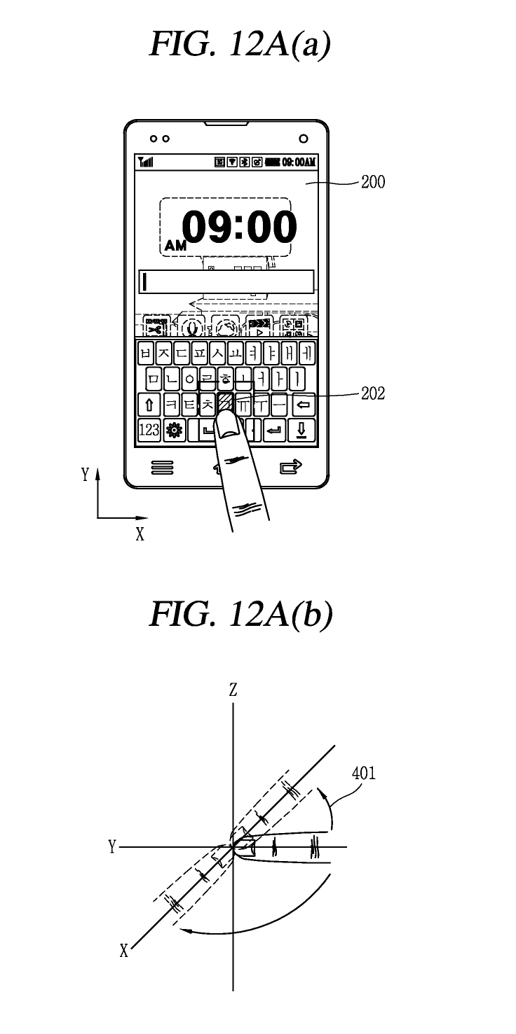

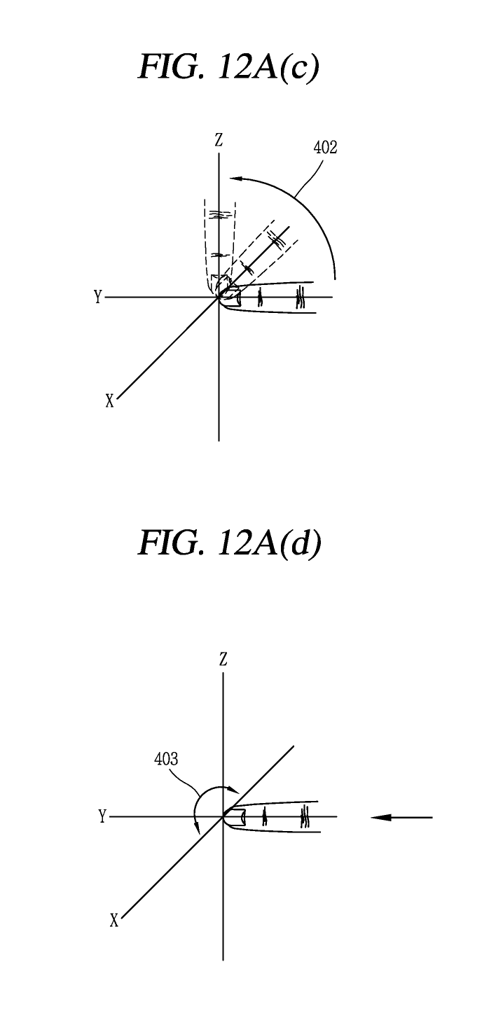

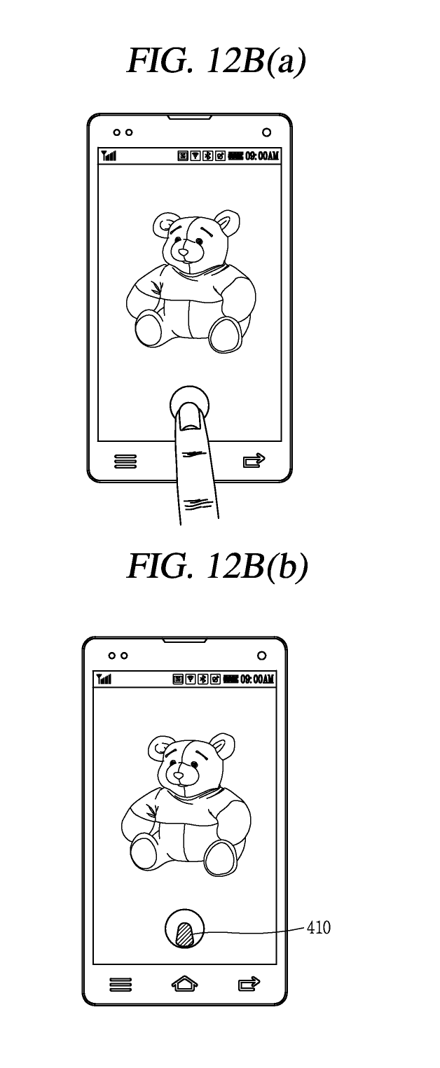

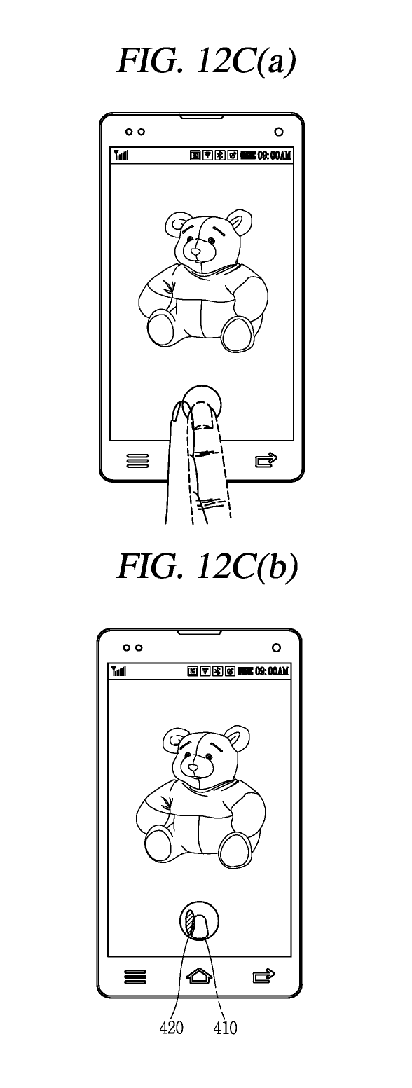

Hereinafter, description will be given of “pivot gesture” as a new control method for a mobile terminal according to the present invention, with reference to FIGS. 12A to 12C. As illustrated in FIG. 12A(a), the controller 180 can sense a touch input and then sense a movement P of a touch object (or a touch tool), which is applied based on a touch point of the touch input.

Hereinafter, the movement of the touch object is defined as “pivot gesture.” In more detail, the controller 180 can sense a behavior, just after a touch input is applied. Examples of such behavior may include a left/right rotation, an up/down rotation, or rolling with respect to the touch object (for example, a finger) centering on the touch point. The movement of the touch object is defined as the pivot gesture, and types of the pivot gesture may include the left/right rotation, the up/down rotation, and the rolling.

Hereinafter, one embodiment of the pivot gesture will be described with reference to FIG. 12A(b). As illustrated in FIG. 12A(a), a display unit having a touch pad may be implemented into an approximately flat structure, and be placed on a plane having virtual X and Y axes. In one embodiment, as illustrated in FIG. 12A(b), the controller 180 can sense a left/right rotation 401 of a finger, which is applied after a touch input is applied, as a pivot gesture.

In more detail, the controller 180 can sense the left/right rotation 401 of the finger, or determine attribute information relating to the left/right rotation 401. For example, the attribute information relating to the left/right rotation 401 may include at least one of a rotation direction (to left or right), a rotation angle and a rotation speed.

That is, when the user applies the pivot gesture on the XY plane, the controller 180 can determine a direction of the pivot gesture and the rotation angle of the pivot gesture. The controller 180 can thus perform a different control command according to the direction and the rotation angle of the pivot gesture.

Hereinafter, another embodiment of the pivot gesture will be described with reference to FIG. 12A(c). As illustrated in FIG. 12A(c), the controller 180 can sense an up/down rotation 402 of the finger, which is applied after a touch input is applied, as the pivot gesture. For example, the up/down rotation 402 may include an operation of erecting the finger which has applied the touch input, or laying down the finger close to the display unit. Therefore, when the user applies a pivot gesture on a YZ plane after applying a touch input, the controller 180 can sense it as a separate control input.

Hereinafter, another embodiment of the pivot gesture will be described with reference to FIG. 12A(d). As illustrated in FIG. 12A(d), the controller 180 can sense a “rolling operation” 403 of a finger, which is applied after a touch input is applied, as a pivot gesture. Here, the “rolling operation” of the finger may refer to an operation that the user rolls the finger to left or right after applying the touch input.

In addition, similar to the description illustrated in FIG. 12A(b), when the up/down rotation and the rolling operation of the finger illustrated in of FIGS. 12A(c) and 12A(d) are applied, the controller 180 can determine attribute information related to each of them. In more detail, the controller 180 can sense at least one of a change in a contact area of the display unit with the touch object, and a direction and a changed degree (extent) of the sensed area change, so as to determine the attribute information related to the pivot gesture.

Hereinafter, description will be given of a method of sensing a change in a contact area between the touch object and the display unit 151. The controller 180 can sense a user's touch input applied to the display unit 151. When the user's touch input is sensed, as illustrated in FIGS. 12B(a) and 12B(b), the controller 180 can recognize a contact region 410 where the touch input has been sensed.

In this state, when the pivot gesture is sensed, the controller 180 can sense whether or not the recognized region has changed. For example, while the user applies the touch input as illustrated in FIG.12B(a), when the user rolls the finger applying the touch input to left as illustrated in FIG. 12C(a) (when applying the rolling operation), the controller 180 can recognize the contact region which changes in response to the rolling of the finger performed by the user. That is, when the finger rolled by the user is sensed as illustrated in FIG. 12C(a), the controller 180 can sense that the contact region 420 illustrated in FIG. 12C(b) has changed, and recognize the changed state.

The controller 180 can also decide attribute information relating to the pivot gesture based on the changed contact region 420. That is, the controller 180 can compare the initial contact region 410 with the changed contact region 420 in response to the finger rolling, and decide attribute information relating to the pivot gesture based on a changed area, a changed direction and a change speed of the contact region. The attribute information may include a direction, a speed and a moved extent of the pivot gesture.

Meanwhile, in FIGS. 12A to 12C, the attribute information relating to the pivot gesture is decided in the manner of sensing the change in the contact area between the touch object and the display unit, but the decision of the attribute information on the pivot gesture may not be limited to this. For example, the controller 180 can sense changes in friction, pressure, static electricity and the like, which are generated between the touch object and the display unit, and decide the attribute information related to the pivot gesture based on the sensed result.

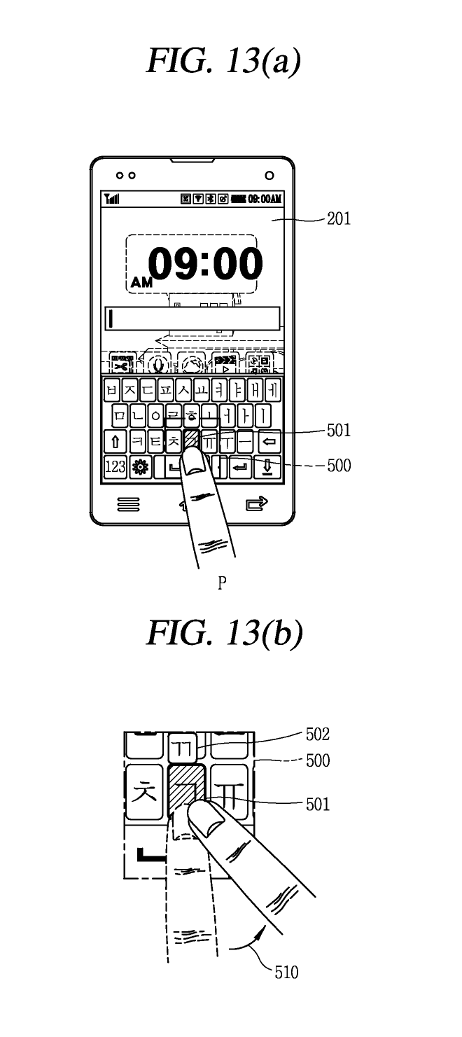

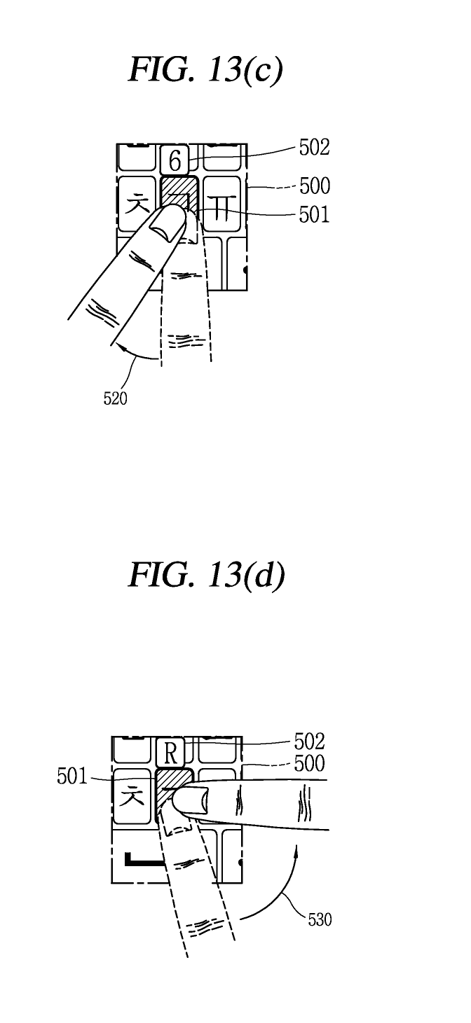

Hereinafter, description will be given of embodiments of performing various functions of the mobile terminal using the defined pivot gesture, with reference to FIGS. 13(a) to 13(d) through 16(a) to 16(c). FIGS. 13(a) to 13(d) illustrate one embodiment in which the controller of the mobile terminal performs keypad switching using a pivot gesture applied to a graphic object having a plurality of keys. For the sake of explanation, FIGS. 13(a) to 13(d) illustrate a case where a pivot gesture of a left/right rotation is applied to the keypad.

As illustrated in FIG. 13(a), the sensing unit 140 may sense a touch input, and a graphic object 501 output on a touch point where the touch input is sensed may be provided with a plurality of keys. Hereinafter, description will be given of a case where the controller 180 senses a user touch input and a pivot gesture P which are applied to a key on which a specific character “ [symbol] ” is set.

When a touch input is sensed and thereafter a pivot gesture P based on a touch point of the touch input is sensed, the controller 180 can switch a character “ [symbol] ,” which is set on a graphic object 501 output on the touch point, into another character. For example, the controller 180 can switch the character “ [symbol] ” set on the graphic object into the character “R,” based on the pivot gesture (refer to FIG. 10(d)). An enlarged area 500 is shown in FIGS. 13(a) to 13(d).

Meanwhile, as illustrated in of FIGS. 13(a) to 13(d), the controller 180 can output a guide image 502 associated with a character to switch on one end of the graphic object, based on the pivot gesture input applied onto the graphic object on which the character “ [symbol] ” has been set. In more detail, as illustrated in FIG. 13(b), the controller 180 can sense the touch input and thereafter sense the pivot gesture 510 based on the touch point of the touch input. Also, while the pivot gesture 510 is applied, the controller 180 can output the guide image 502 associated with the character to switch based on the pivot gesture 510. For example, when the pivot gesture 510 applied onto the graphic object indicating the character “ [symbol] ” is sensed, the controller 180 can switch the character “ [symbol] ” into a character “ [symbol] .”

In addition, the controller 180 can output the guide image 502 for indicating the character “ [symbol] ” to switch on the one end of the graphic object. Accordingly, the user can check information related to the character to switch through the output guide image 502. The method by which the controller 180 outputs the guide image 502 may not be limited to that illustrated in FIGS. 13(a) to 13(d). The controller 180 can also output a guide image including a plurality of key information. When the controller 180 outputs the guide image including the plurality of key information, a key to switch may be selected from the plurality of keys based on the sensed pivot gesture 510.

Comparing FIGS. 13(b) and 13(c), the controller 180 can perform different functions according to the changes in the contact region between the touch object applying a touch input and the display unit, which results from pivot gestures 510 to 530. In more detail, the controller 180 can perform a different function based on a rotation direction, a rotation angle and the like of the applied pivot gesture of the left/right rotation.

For example, comparing the pivot gestures 510 and 520 illustrated in of FIGS. 13(b) and 13(c), the controller 180 can output the guide image 502 indicating different characters “ [symbol] ” and “6,” respectively, according to the rotation direction of the pivot gestures 510 and 520. As another example, comparing the pivot gestures 510 and 530 illustrated in FIGS. 13(b) and 13(d), the controller 180 can output the guide image 502 indicating the different characters “ [symbol] ” and “R,” respectively, according to the rotation angle of the pivot gestures 510 and 530.

Meanwhile, the controller 180 can perform a different function according to a type of pivot gesture applied. For example, when the pivot gesture of the left/right rotation is applied to the graphic object including the key “ [symbol] ,” the controller 180 can switch the key into another key. When the pivot gesture of the up/down rotation is applied to the graphic object, the controller 180 can change an output manner of the whole keyboard.

As such, when a key switching function of the virtual keyboard is performed using the pivot gesture, the mobile terminal according to the present invention may merely require for a simple user input (namely, the pivot gesture), as compared with the related art mobile terminal, in which the user had to switch character information to be displayed on a keypad by applying a plurality of touch inputs. Therefore, the mobile terminal disclosed herein may enhance the user's convenience.

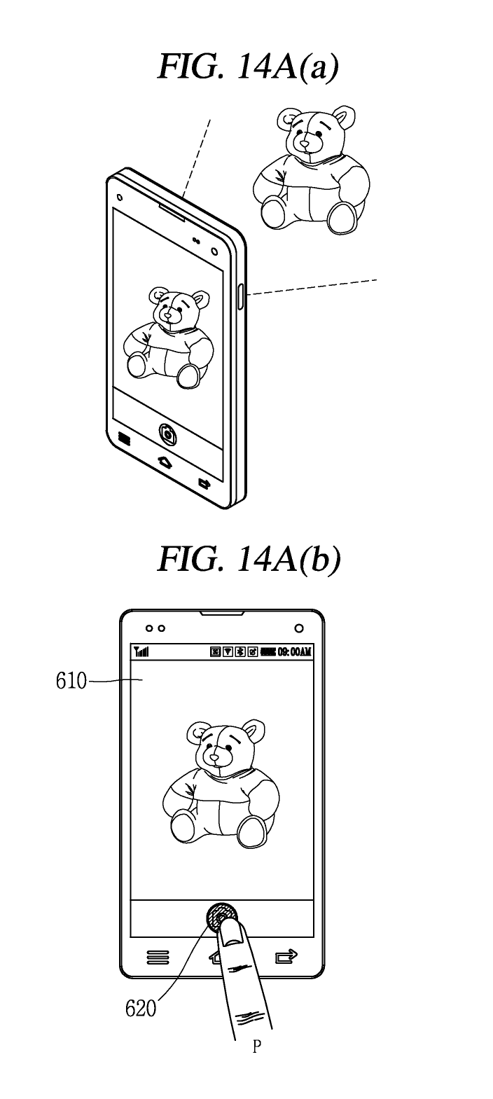

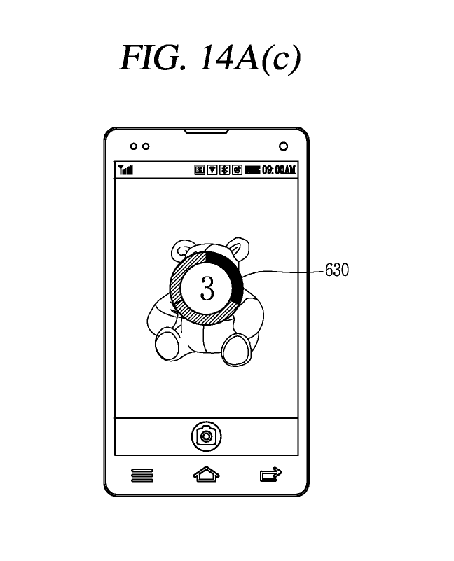

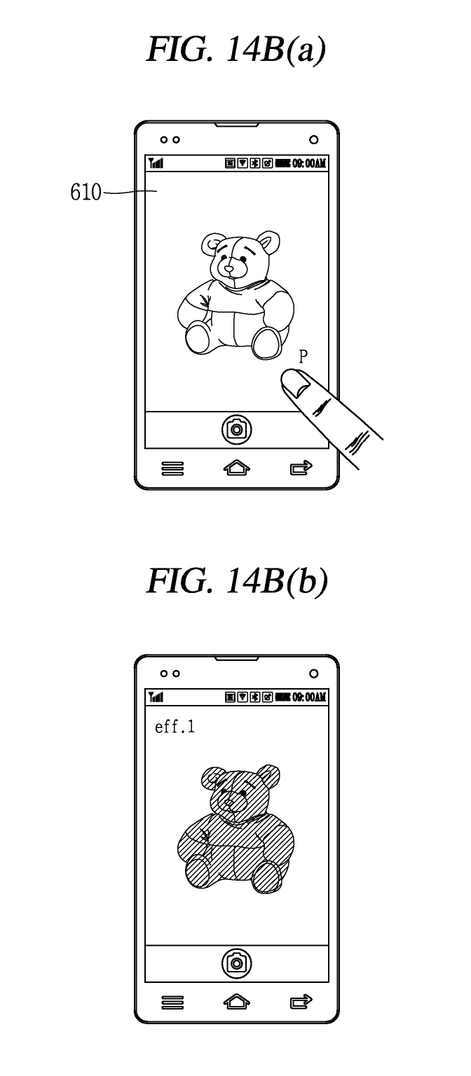

FIGS. 14A and 14B illustrate a method of controlling a camera capturing function using a pivot gesture in a mobile terminal in accordance with an embodiment disclosed herein. As illustrated in FIG. 14A(a), the camera 121 provided in the mobile terminal may capture an image with respect to a specific object to be captured. The controller 180 can output a preview image acquired by the camera 121 on the display unit.

As illustrated in FIGS. 14A(b) and 14A(c), when a touch input is applied and thereafter a pivot gesture P is sensed on a touch point of the touch input, if a graphic object output on the touch point is a capture button, the controller 180 can perform a timer capturing function with respect to the preview image.

In more detail, while a preview image 610 is output on the display unit, when a left/right rotation pivot gesture P is applied to an image capture button 620, the controller 180 can perform the timer capturing function with respect to the preview image 610. Here, the controller 180 can output a guide image 630 indicating timer information on the display unit.

Also, the controller 180 can set the timer information according to a rotation angle of the left/right rotation pivot gesture P. For example, when the rotation angle of the left-right rotation pivot gesture P is 15°, and when three seconds elapse after the pivot gesture is released, the controller 180 can perform an image capturing function with respect to the preview image 610. As another example, in case where the rotation angle is 30°, when five seconds elapse after the pivot gesture is released, the controller 180 can perform the image capturing function with respect to the preview image 610.

Meanwhile, as illustrated in FIG. 14B(a), when the touch input is applied on the preview image 610 and thereafter the pivot gesture P is applied, the controller 180 can apply a preset image effect to the preview image 610. For example, the preset image effect may include a black-and-while image effect, a negative image effect and the like.

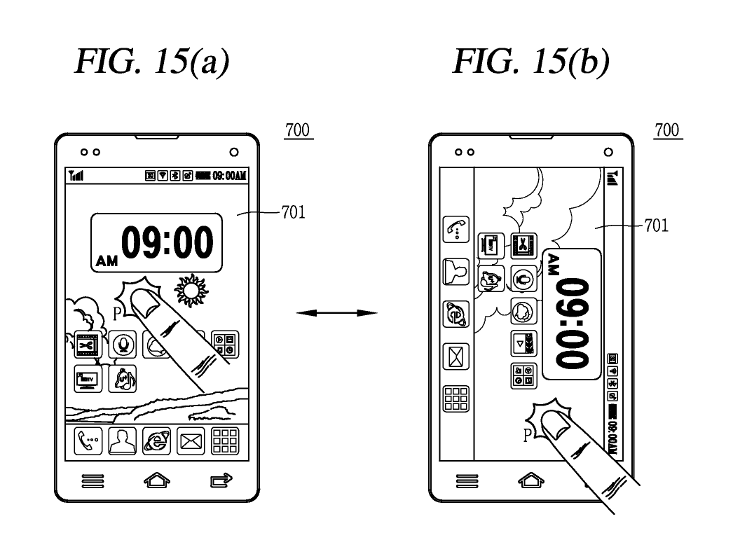

FIGS. 15(a) and 15(b) illustrate a method of switching an output direction of a display unit using a pivot gesture in a mobile terminal in accordance with an embodiment. As illustrated in of FIGS. 15(a) and 15(b), the controller 180 can switch an output direction of a graphic object, which is output on a touch point with a pivot gesture P applied thereto, using the pivot gesture P.

In more detail, while a home screen 701 is displayed on a display unit of a mobile terminal 700, when a touch input and a pivot gesture P are applied to the home screen 701, the controller 180 can switch an output direction of the home screen 701. For example, when an output direction of the home screen 701 is one of a landscape direction and a portrait direction, and when the pivot gesture P is sensed, the controller 180 can switch the output direction of the home screen 701 into the other of the landscape direction and the portrait direction.

In general, the controller 180 can decide an output direction of the display unit or a graphic object output on the display unit based on setting information related to the output direction. However, as illustrated in FIGS. 15(a) and 15(b), when the output direction of the display unit is switched using the pivot gesture P, the controller 180 can control the output direction, irrespective of the setting information related to the output direction. That is, the controller 180 can decide the output direction of the display unit, taking into account the output direction of the display unit and attribute information relating to the pivot gesture P.

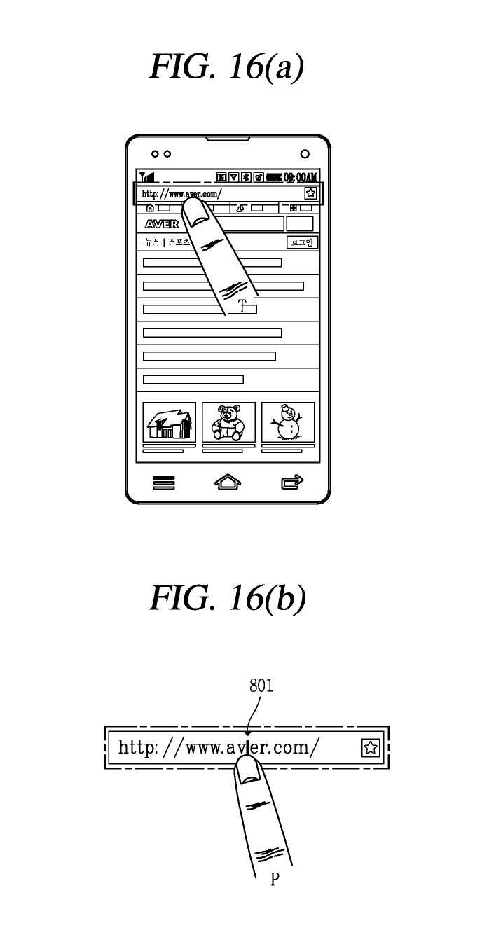

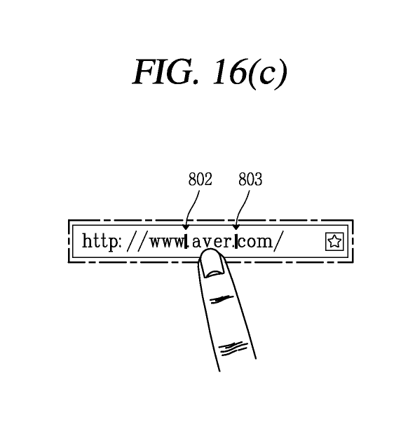

FIGS. 16(a) to 16(c) illustrate a method of moving a cursor on text information output on a display unit using a pivot gesture in a mobile terminal in accordance with an embodiment. As illustrated in FIGS. 16(a) to 16(c), when a pivot gesture P is applied to a graphic object including text, the controller 180 can move an active position of a cursor on the output text based on the pivot gesture P.

For example, when a touch input is applied to the graphic object including text, the controller 180 can decide an active position of the cursor as a touch point 801. Afterwards, when a rolling pivot gesture P is applied in a left direction after the touch input is applied, the controller 180 can move (802) the active position of the cursor to left on the text based on the pivot gesture P. In an opposite case, the controller 180 can move (803) the active position of the cursor to right.

Meanwhile, although not illustrated in FIGS. 16(a) to 16(c), even when the pivot gesture is not applied directly onto a text output region but applied to a preset partial region of the display unit 151, the controller 180 can adjust the active position of the cursor on the text. In such a manner, by adjusting the active position of the cursor on the text output on the display unit 151 based on the pivot gesture P applied, the controller 180 can reflect the user's intent more actively in view of deciding the active position of the cursor.

As described above, the present disclosure provides a mobile terminal, which is capable of performing various functions using a movement of a touch object (or a touch tool), which is applied after a user's touch input, and a control method thereof. This may result in an extension of an operation range of the user's terminal. Also, the number of touch inputs required when the user performs a specific function can be reduced, thereby enhancing user convenience.

As discussed above, according to a mobile terminal and a control method thereof disclosed herein, the use of a touch input applied to an icon may allow for switching a user interface associated with an execution of a corresponding application from a touch-based type into another type of user interface, and simultaneously an immediate execution of the corresponding application. This may result in solving the user' inconvenience, which is caused due to the user having to performing several steps for switching a user interface for a specific application into a gesture interface. Also, other user interfaces can be easily added or switched while outputting an execution screen of an application, providing the user with convenience in use. In addition, when the user interface changes, an output screen may be reconfigured to be appropriate for the changed user interface, thereby providing screen information suitable for a current interface environment. Various functions of the mobile terminal can be controlled by using a movement of a finger which the user applies after applying a touch input, resulting in an extension of terminal operating range. Also, the number of touch inputs required when the user performs a specific function can be reduced, thereby enhancing user convenience.

Further, in accordance with one embodiment of the present disclosure, the method can be implemented as computer-readable codes in a program-recorded medium. The computer-readable medium may include all types of recording devices each storing data readable by a computer system. Examples of such computer-readable media may include ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the mobile terminal. Therefore, the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal, comprising:
a touch screen configured to display an object associated with an application; and
a controller configured to:
receive a touch input applied to the object and a pivot gesture input applied based on a touch point of the received touch input, and
activate an interface setting mode for changing a user interface associated with executing the application based on the pivot gesture input.

2. The mobile terminal of claim 1, wherein the pivot gesture input corresponds to a change in a part of the touch point, or an input applied by a continuous touch movement starting from the touch point.

3. The mobile terminal of claim 1, wherein the controller is further configured to display a graphic object on the touch screen indicating a changeable or switchable user interface corresponding to the pivot gesture input, when the interface setting mode is activated.

4. The mobile terminal of claim 3, wherein the changeable or switchable user interface comprises at least one of a gesture interface, a voice interface, an image interface and an eye-tracking interface, and
wherein the controller is further configured to display the graphic object overlapping at least part of the object or near the object.

5. The mobile terminal of claim 1, wherein the controller is further configured to:
activate the interface setting mode, when the pivot gesture input is sensed within a reference time after the touch input is received, and
execute another function associated with the object when the reference time elapses.

6. The mobile terminal of claim 5, wherein the controller is further configured to switch displaying the object from a two-dimensional (2D) image into a three-dimensional (3D) image when a changed degree of the touch point in response to the pivot gesture input exceeds a reference range.

7. The mobile terminal of claim 6, wherein the controller is further configured to control an execution of the application corresponding to the object switched into the 3D image through a 3D gesture when the pivot gesture input is released.

8. The mobile terminal of claim 1, wherein the controller is further configured to:
display a registration screen on one region of the touch screen when the pivot gesture input is received on a point outside the object on the touch screen, the registration screen being displayed for registering at least one application for which the user interface is to change,
switch the object into a movable state,
receive a touch and drag input of the object into the registration screen, and
register the application associated with the moved object by changing the user interface of the application based on the touch and drag input.

9. The mobile terminal of claim 1, wherein the controller is further configured to:
select a different user interface based on a degree that a part of the touch point gradually changes in response to the pivot gesture input, while the interface setting mode is activated, and
display a different graphic object corresponding to the different user interface on the touch screen.

10. The mobile terminal of claim 9, wherein the controller is further configured to:
determine a direction and a degree that a touch object applying the touch input rotates based on the touch point, based on a pattern that a region corresponding to the touch point of the touch input is gradually changed in response to the pivot gesture input, and
switch the user interface associated with executing the application into a different type based on a rotation degree when a rotation direction of a touch object used for touching the object matches a preset direction.

11. The mobile terminal of claim 10, wherein the controller is further configured to:
display an indicator on the object when the pivot gesture input is released, the indicator indicating the user interface changed based on the rotation degree, and
restore the changed user interface to a previous type without the displayed indicator, when another pivot gesture input including a rotation direction opposite to the rotation direction is received while the interface setting mode is activated.

12. The mobile terminal of claim 1, wherein the controller is further configured to display an execution screen of the application corresponding to the object through the changed user interface when the pivot gesture input is released.

13. The mobile terminal of claim 12, wherein the controller is further configured to control the execution of the application based on a proximity touch being maintained for a reference time after the pivot gesture input.

14. The mobile ten final of claim 1, wherein the controller is further configured to:
display a plurality of graphic objects on the touch screen indicating changeable user interfaces, when the pivot gesture input is released, and
control an execution of an application corresponding to at least one selected graphic object through a corresponding user interface.

15. A mobile terminal, comprising:
a touch screen configured to display an object associated with an application; and
a controller configured to:
receive a touch input applied to the object,
execute the application and display an execution screen of the executing application,
receive a pivot gesture input on the displayed execution screen, and
change a user interface for executing the application based on the received pivot gesture input.

16. The mobile terminal of claim 15, wherein the pivot gesture input corresponds to a change in a part of the touch point, or an input applied by a continuous touch movement.

17. The mobile terminal of claim 15, wherein the controller is further configured to change the user interface based on an angle between a touch object applying the touch input and the touch screen, and based on a pattern that a region corresponding to the touch point of the touch input is gradually changed while the pivot gesture input is received.

18. The mobile terminal of claim 17, wherein the controller is further configured to:
differently change a number of added other user interfaces in response to an increase in the angle, and
display a graphic object indicating the added other user interface on the touch screen.

19. The mobile terminal of claim 15, wherein the controller is further configured to:
remove an indicator display region indicating an operating state of the mobile terminal and an input region associated with the execution from the touch screen such that a screen corresponding to the execution of the application is increased in size, when the application corresponding to the object is executed in response to the release of the pivot gesture input.

20. The mobile terminal of claim 15, wherein the controller is further configured to:
display guide information on the touch screen for guiding a processing of an event using the changed user interface, when the event is generated in another application and is received in response to the release of the pivot gesture input while the application associated with the object is executed.
